(19) United States
(12) Patent Application Publication
(10) Pub. No.: US 2020/0372597 A1
(43) Pub. Date: Nov. 26, 2020

(54) METHOD FOR OBJECT-CENTRIC SERVICE DELIVERY

(71) Applicant: ALFRED CHEUNG, SAN FRANCISCO, CA (US)

(72) Inventor: ALFRED CHEUNG, SAN FRANCISCO, CA (US)

(21) Appl. No.: 16/421,478

(22) Filed: May 24, 2019

(51) Int. Cl. G06Q 50/20; G06Q 40/02

(52) U.S. Cl. CPC G06Q 50/2053; G06Q 40/02

(57) ABSTRACT

A method, system and computer-usable medium for object-centric service delivery are presented. The method includes determining an individualized information of an object and sending the individualized information of the object to an object-centric service delivery system (OSDS). The method includes, creating a request for a financial aid and sending the request to the OSDS. The request including an intended use of the financial aid and a financial aid value. The method further includes receiving an integrated OSDS container. The OSDS container including a financial aid value and a set of rules for utilizing the financial aid. The set of rules for utilizing the financial aid are based on set of rules of one or more OSDS containers. Thereafter, the method includes receiving recommendation of one or more service actions, wherein the one or more service actions facilitate the object in attaining the desired state.

### BACKGROUND

Players in the social welfare ecosystem, such as government organizations, non-profit agencies and charities need to maximize the reach and efficiency of their resources. However, many such entities, including cities, counties, non-profit agencies and charities still depend on MS-Excel® spreadsheets, emails, and one-dimensional software solutions to manage and track their numerous social welfare programs. Managing and tracking complex programs through MS-Excel and emails is extremely time consuming and prone to errors. One-dimensional software solutions, such as document management solution, finance/accounting solution, content management system (CMS), project management software etc. solve only part of the problem. Preparation, tracking, managing, forecasting, predicting, reporting, analysis and compliance obligations for social welfare programs require an integrated approach.

It is with respect to these and other general considerations that aspects disclosed herein have been made. Also, although relatively specific problems may be discussed, it should be understood that the aspects should not be limited to solving the specific problems identified in the background or elsewhere in this disclosure.

### SUMMARY

In summary, the disclosure generally relates to method, system and computer-usable medium for object-centric service delivery. In an embodiment, an object-centric service delivery system (OSDS) enables donors, charities, non-profits to manage social good initiatives for objects, such as individuals, families and other entities.

The method includes creating a plurality of OSDS containers. Each OSDS container corresponds to a financial asset. Each OSDS container includes a financial asset value, a plurality of attributes and a set of rules. The financial asset is required to comply with the set of rules. The method includes receiving a request for a financial aid. The request for the financial aid includes at least one intended use of the financial aid. The method further includes determining one or more OSDS containers that match the request for the financial aid. This match is based on at least one of from the group including the at least one intended use of the financial aid, the financial asset value of at least one OSDS container and the set of rules of the at least one OSDS container. The method further includes, generating an integrated OSDS container from one or more OSDS containers. The integrated OSDS container is configured to service request for a financial aid. The integrated OSDS container includes a financial aid value, and a set of rules for utilizing the financial aid. The set of rules for utilizing the financial aid are based on the set of rules of the one or more OSDS containers. Finally, the method includes associating the financial aid value and the set of rules for utilizing the financial aid with the integrated OSDS container.

One aspect of the invention is directed towards a computer-implementable method executed by at least one processor in a computer system. The computer-implementable method includes:

creating a plurality of object-centric service delivery system (OSDS) containers, an OSDS container corresponding to a financial asset, the OSDS container comprises a financial asset value, a plurality of attributes and a set of rules, wherein the financial asset is required to comply with the set of rules;

receiving a request for a financial aid, the request for the financial aid comprises at least one intended use of the financial aid;

determining one or more OSDS containers that match the request for the financial aid, wherein the match is based on at least one of from the group comprising the at least one intended use of the financial aid, the financial asset value of at least one OSDS container and set of rules of the at least one OSDS container;

generating an integrated OSDS container from the one or more OSDS containers, wherein the integrated OSDS container is configured to service the request for the financial aid, wherein the said generating comprises:

determining a financial aid value; and

creating a set of rules for utilizing the financial aid, wherein the set of rules for utilizing the financial aid are based on the set of rules of the one or more OSDS containers; and

associating the financial aid value and the set of rules for utilizing the financial aid with the integrated OSDS container.

Another aspect of the disclosure is directed to a tangible computer-usable medium on which is stored computer program code, the computer program code including computer executable instructions configured to:

create a plurality of object-centric service delivery system (OSDS) containers, an OSDS container corresponding to a financial asset, the OSDS container comprises a financial asset value, a plurality of attributes and a set of rules, wherein the financial asset is required to comply with the set of rules;

receive a request for a financial aid, the request for the financial aid comprises at least one intended use of the financial aid;

determine one or more OSDS containers that match the request for the financial aid, wherein the match is based on at least one of from the group comprising the at least one intended use of the financial aid, the financial asset value of at least one OSDS container and set of rules of the at least one OSDS container;

generate an integrated OSDS container from the one or more OSDS containers, wherein the integrated OSDS container is configured to service the request for the financial aid, wherein the said generate comprises:

determining a financial aid value; and

creating a set of rules for utilizing the financial aid, wherein the set of rules for utilizing the financial aid are based on the set of rules of the one or more OSDS containers; and

associating the financial aid value and the set of rules for utilizing the financial aid with the integrated OSDS container.

One aspect of the invention is directed towards a system including:

a processor;

a data bus coupled to the processor;

a memory coupled to the data bus; and

a computer-usable medium embodying computer program code, the computer program code including instructions executable by the processor and configured to:

create a plurality of object-centric service delivery system (OSDS) containers, an OSDS container corresponding to a financial asset, the OSDS container comprises a financial asset value, a plurality of attributes and a set of rules, wherein the financial asset is required to comply with the set of rules;

receive a request for a financial aid, the request for the financial aid comprises at least one intended use of the financial aid;

determine one or more OSDS containers that match the request for the financial aid, wherein the match is based on at least one of from the group comprising the at least one intended use of the financial aid, the financial asset value of at least one OSDS container and set of rules of the at least one OSDS container;

generate an integrated OSDS container from the one or more OSDS containers, wherein the integrated OSDS container is configured to service the request for the financial aid, wherein the said generate comprises:

determining a financial aid value; and

creating a set of rules for utilizing the financial aid, wherein the set of rules for utilizing the financial aid are based on the set of rules of the one or more OSDS containers; and

associating the financial aid value and the set of rules for utilizing the financial aid with the integrated OSDS container.

A method of object-centric service delivery is disclosed. The method includes determining an individualized information of an object. The object is from a plurality of objects. The individualized information including one or more performance parameters. A performance parameter covers a performance area of the object and has a set of performance values. The method includes sending the individualized information of the object to an object-centric service delivery system (OSDS). The method also includes creating a request for a financial aid. The request for the financial aid includes an intended use of the financial aid, and a financial aid value. Thereafter, the method includes, sending the request for the financial aid to the OSDS. The method further includes, receiving an integrated OSDS container. The integrated OSDS container is configured to service the request for the financial aid. The integrated OSDS container comprises a financial aid value and a set of rules for utilizing the financial aid. The set of rules for utilizing the financial aid are based on set of rules of one or more OSDS containers. The method also includes, receiving recommendation of one or more service actions. The one or more service actions facilitate the object in attaining the desired state. The recommendation of one or more service actions is based on an analysis of the individualized information of the object and individualized information of other objects that are contextually related to the object. The other objects are from the plurality of objects.

One aspect of the invention is directed towards a method of object-centric service delivery. The method being executed by at least one processor in a computer system, the method includes:

determining an individualized information of an object, wherein the object is from a plurality of objects, the individualized information comprising one or more performance parameters, wherein a performance parameter covers a performance area of the object, and wherein the performance parameter has a set of performance values;

sending the individualized information of the object to an object-centric service delivery system (OSDS);

creating a request for a financial aid, the request for the financial aid comprises an intended use of the financial aid, and a financial aid value;

sending the request for the financial aid to the OSDS;

receiving an integrated OSDS container wherein the integrated OSDS container is configured to service the request for the financial aid, wherein the integrated OSDS container comprises a financial aid value and a set of rules for utilizing the financial aid, wherein the set of rules for utilizing the financial aid are based on set of rules of one or more OSDS containers;

receiving recommendation of one or more service actions, wherein the one or more service actions facilitate the object in attaining the desired state, and wherein the recommendation of one or more service actions is based on an analysis of the individualized information of the object and individualized information of other objects that are contextually related to the object, wherein the other objects are from the plurality of objects.

One aspect of the invention is directed towards a system including:

a processor;

a data bus coupled to the processor;

a memory coupled to the data bus; and

a computer-usable medium embodying computer program code, the computer program code including instructions executable by the processor and configured to:

determine an individualized information of an object, wherein the object is from a plurality of objects, the individualized information comprising one or more performance parameters, wherein a performance parameter covers a performance area of the object, and wherein the performance parameter has a set of performance values;

send the individualized information of the object to an object-centric service delivery system (OSDS);

create a request for a financial aid, the request for the financial aid comprises an intended use of the financial aid, and a financial aid value;

send the request for the financial aid to the OSDS;

receive an integrated OSDS container wherein the integrated OSDS container is configured to service the request for the financial aid, wherein the integrated OSDS container comprises a financial aid value and a set of rules for utilizing the financial aid, wherein the set of rules for utilizing the financial aid are based on set of rules of one or more OSDS containers;

receive recommendation of one or more service actions, wherein the one or more service actions facilitate the object in attaining the desired state, and wherein the recommendation of one or more service actions is based on an analysis of the individualized information of the object and individualized information of other objects that are contextually related to the object, wherein the other objects are from the plurality of objects.

Another aspect of the disclosure is directed to a computer-implementable method of object-centric service delivery executed by at least one processor in a computer system, the computer-implementable method comprising:

creating an individualized information of an object, wherein the object is from a plurality of objects, the individualized information comprising one or more performance parameters, wherein a performance parameter covers a performance area of the object, and wherein the performance parameter has a set of performance values;

sending the individualized information of the object to an object-centric service delivery system (OSDS);

receiving recommendation of one or more service actions from the OSDS, wherein the one or more service actions facilitate the object in attaining the desired state, and wherein the recommendation of one or more service actions is based on an analysis of the individualized information of the object and individualized information of other objects that are contextually related to the object, wherein the other objects are from the plurality of objects; and

selecting at least one service action from the one or more service actions.

Another aspect of the disclosure is directed to a computer program product, comprising a computer readable storage medium having program instructions embodied therewith, wherein the computer readable storage medium is not a transitory signal per se, the program instructions readable by at least one processing circuit to cause the at least one processing circuit to perform a method of object centric service delivery, the method comprising:

determining an individualized information of an object, wherein the object is from a plurality of objects, the individualized information comprising one or more performance parameters, wherein a performance parameter covers a performance area of the object, and wherein the performance parameter has a set of performance values;

sending the individualized information of the object to an object-centric service delivery system (OSDS);

creating a request for a financial aid, the request for the financial aid comprises an intended use of the financial aid, and a financial aid value;

sending the request for the financial aid to the object-centric service delivery system (OSDS);

receiving an integrated OSDS container wherein the integrated OSDS container is configured to service the request for the financial aid, wherein the integrated OSDS container comprises a financial aid value and a set of rules for utilizing the financial aid, wherein the set of rules for utilizing the financial aid are based on set of rules of one or more OSDS containers;

receiving recommendation of one or more service actions, wherein the one or more service actions facilitate the object in attaining the desired state, and wherein the recommendation of one or more service actions is based on an analysis of the individualized information of the object and individualized information of other objects that are contextually related to the object, wherein the other objects are from the plurality of objects.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

The accompanying figures, where like reference numerals refer to identical or functionally similar elements throughout the separate views, and which, together with the detailed description below, are incorporated in and form part of the specification, serve to further illustrate various embodiments and explain various principles and advantages, all in accordance with the present invention.

FIG. 1 is a block diagram that illustrates an environment 100 in accordance with various embodiments of the present invention;

FIG. 2 is a block diagram that illustrates an environment 200 in accordance with various embodiments of the present invention;

FIG. 3 is a block diagram illustrating the exemplary database 210 in accordance with various embodiments of the present invention;

FIG. 4 provides a block diagram depicting the funder 124 in accordance with various embodiments of the present invention;

FIG. 5 is a flowchart illustrating an exemplary method 500 for object-centric service delivery according to various embodiments of the present invention.

FIG. 6 is a flowchart illustrating an exemplary method 600 for object-centric service delivery according to various embodiments of the present invention.

FIG. 7 provides a block diagram depicting an environment 700 of mobile radio infrastructure in accordance with various embodiments of the present invention.

FIG. 8 is a flowchart illustrating an exemplary method 800 for object-centric service delivery according to various embodiments of the present invention.

FIG. 9 is a block diagram illustrating physical components (e.g., hardware) of a computing device 900 with which aspects of the disclosure may be practiced.

Skilled artisans will appreciate that elements in the figures are illustrated for simplicity and clarity and have not necessarily been drawn to scale. For example, the dimensions of some of the elements in the figures may be exaggerated, relative to other elements, to help in improving an understanding of the embodiments of the present invention.

### DETAILED DESCRIPTION

In the following detailed description, references are made to the accompanying drawings that form a part hereof, and in which are shown by way of illustrations specific aspects or examples. These aspects may be combined, other aspects may be utilized, and structural changes may be made without departing from the spirit or scope of the present disclosure. The following detailed description is therefore not to be taken in a limiting sense, and the scope of the present disclosure is defined by the claims and their equivalents.

In this document, the terms “comprises,” “comprising,” or any other variation thereof, are intended to cover a non-exclusive inclusion, such that a process, method, article or apparatus that comprises a list of elements does not include only those elements but may include other elements that are not expressly listed or inherent in such a process, method, article or apparatus. An element proceeded by “comprises . . . a” does not, without more constraints, preclude the existence of additional identical elements in the process, method, article or apparatus that comprises the element.

The term “another,” as used in this document, is defined as at least a second or more. The terms “includes” and/or “having,” as used herein, are defined as comprising. The term “program,” as used herein, is defined as a sequence of instructions designed for execution on a specialized computer system. A “program,” or “computer program,” may include a subroutine, a function, a procedure, an object method, an object implementation, an executable application, an applet, a servlet, a source code, an object code, a shared library/dynamic load library and/or other sequence of instructions designed for execution on a specialized computer system.

Certain portions of this application, such as the Abstract and Summary, are provided to allow the reader to quickly ascertain the nature of the disclosure. They are submitted with the understanding that they will not be used to interpret or limit the scope or meaning of the claims.

Social welfare is a service that benefits large sections of the society, especially, the economically and socially challenged sections of the society. Social welfare ecosystem includes three kinds of players, namely “funders”, “implementers” and “objects”.

A funder is an entity or individual that funds social welfare schemes and/or programs. Examples of the funders include, but are not limited to, government entities, private foundations, businesses, charities and philanthropic individuals. Funders, in aggregate, provide Billions of dollars of financial aid every year for social welfare schemes and/or programs to help individuals, families and entities, such as small businesses in need. The financial aid could be a donation, a grant, an aid, a bequest, a gift, a scholarship, a charitable donation, a loan or any other kind of cash or non-cash assistance provided by the funder. The financial aid could be anything of value and can be cash or non-cash. Examples of non-cash financial aid include, but are not limited to stocks, real estate, clothing, furniture, household items, wine collections, art, jewelry, antiques, collectibles, automobiles, boats and recreational vehicles.

An implementer includes entities, for example, non-profit organizations and government agencies which actively carry out social welfare schemes and/or programs to generate social good. The implementer uses financial aid received from one or more funders to organize social good initiatives by acquiring resources and employing people.

The implementer routinely gives assistance to those in need in terms of money, materials, time, volunteer support, technical assistance, religious guidance, emotional comfort, safe heaven and counseling. Typically, the implementer includes all sorts of entities, for example those which aid in areas such as education, religious programs, health care, international support, peace efforts, homeless, abuse prevention, disaster relief, veteran programs, historical preservation, youth development, arts, wildlife and environment. Finally, an object includes individuals, families and entities, such as, small businesses in need, who receive benefits of social welfare schemes and/or programs carried out by the implementer. The term, “object” as used herein, is same as “recipient” and has been used interchangeably.

The players in this social welfare ecosystem, for example, funders and implementers need to maximize the efficiency of their resources so that they can reach out to more and more potential recipients in need. However, many of these players, such as cities, counties, charities, and non-profits depend upon MS-Excel® spreadsheets, emails and one-dimensional software solutions to manage their social welfare schemes and programs.

Management through spreadsheets and emails is time consuming and prone to errors. The one-dimensional software solutions, for example Enterprise Resource Planning (ERP), Supply Chain Management (SCM) implemented by one player is often incompatible and disconnected with IT systems and databases used by other players in the social welfare ecosystem. This leads to overheads and inefficiencies. Therefore, in effect, Billions of dollars, meant to help recipients, are being managed by inefficient, fractured and segregated systems. As such, there is currently no system that provides an ingenerated solution to address these issues. This lack of integration also results in mismatch between demand and supply. For example, due to the lack of integration, the welfare schemes and/or programs are planned without a comprehensive information about the needs of the recipients. This further amplifies the inefficiencies within the social welfare ecosystem.

Since this entire social welfare ecosystem revolves around financial aid which flow from one player to another, typically, each recipient of a financial aid is required to comply with rules prescribed by one or more players that are above it in the flow of the financial aid. For example, the funds for community health care clinics may flow from US federal government to state, then to county, and eventually to a non-profit organization that runs the health clinic in the county. In this example, each of these players may specify rules on how the funds should or should not be used. For example, the US federal Government may specify a rule that no more than 70% of the financial aid should be used for medical supplies. All players below the US federal government, for example, the state, the county and the non-profit running the health care clinic must comply with this rule of the US federal government for the financial aid. To add to the complexity, the state and the county may provide additional rules of their own. In addition, the states and/or the county may provide addition financial aid and specify additional rules. For example, the state may provide an additional financial aid to the health care clinic with a restriction that no part of the funds should be spent on salaries. Similarly, the county may provide an additional financial aid and may impose a requirement that the funds should be spent only on food supplies. Thus, in this example, the health care clinic gets three different funds with three different set of rules to comply with. Most cities, counties and non-profits still rely on MS-Excel or one-dimensional software solutions to manage and track their compliance and thus spend an exorbitant amount of time and money to meet their compliance obligations.

A computer implementable method, system and computer-usable medium for object-centric service delivery has been disclosed herein. The method and system provide management and compliance. They also adapt to current and future compliance requirements. Typically, the method and system are implemented on an object-centric service delivery system (OSDS). The OSDS provides an integrated solution for unified funding, program and operations management platform for the various players in the social welfare ecosystem.

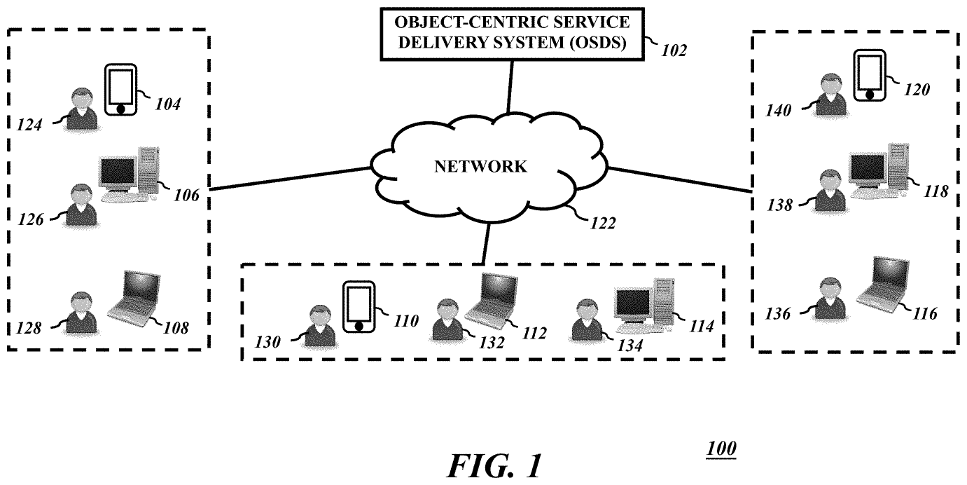

FIG. 1 is a block diagram that illustrates environment 100 where various embodiments of the present invention may be practiced. The environment 100 includes an object-centric service delivery system (OSDS) 102, a plurality of client devices, for example, a client device 104, a client device 106, a client device 108, a client device 110, a client device 112, a client device 114, a client device 116, a client device 118, and a client device 120. Each client device of the plurality of client devices is connected to the OSDS 102 via a network 122.

In various embodiments the OSDS 102 may comprise or utilize a special purpose or general-purpose computing system including computer hardware, such as, for example, one or more processors and system memory. In an embodiment, the OSDS 102 may be implemented as a distributed system, for example one or more elements of the OSDS 102 may be located across a wide-area network from other elements of the OSDS 102. In another embodiment, the OSDS 102 may be implemented as a standalone server. In yet another embodiment, the OSDS 102 may be implemented over a cloud as a Software as a Service (SaaS). In an embodiment, when the OSDS 102 is implemented over a cloud, the OSDS 102 may provide computer program code to its customers such as to the funders, the implementers and the objects on an on-demand basis, for example, monthly or annual subscription.

Examples of a client device, for example the client device 104 include, but are not limited to, a handheld computer, a personal digital assistant (PDA), a tablet computer, a laptop computer, a desktop computer, a cellular telephone, a smart phone, an enhanced general packet radio service (EGPRS) mobile phone, a media player, a navigation device, a game console, a television, a remote control, or a combination of any two or more of these data processing devices or other data processing devices.

The network 122 may include local-area networks (LAN), wide-area networks (WAN), wireless networks (e.g., 802.11 or cellular network), the Public Switched Telephone Network (PSTN) network, ad-hoc networks, personal area networks (e.g., Bluetooth) or other combinations or permutations of network protocols and network types. The network 122 may include a single local area network (LAN) or wide-area network (WAN), or combinations of LAN's or WAN's, such as the Internet. In an embodiment, the various client devices, for example, the client device 104 is coupled to the network 122 via one or more wired or wireless connections.

The environment 100 further includes a plurality of funders, for example, funder 124, a funder 126 and a funder 128; one or more implementers, for example an implementer 130, an implementer 132, and an implementer 134 and a plurality of objects, for example an object 136, an object 138 and an object 140.

A funder, for example funder 124 is an entity or individual that funds social welfare schemes and/or programs. Examples of the funders include government entities, private foundations, businesses, and philanthropic individuals. Funders, in aggregate, spend Billions of dollars every year on social welfare schemes and/or programs to help individuals, families and small businesses in need.

Implementers, for example the implementer 132 include entities, for example, non-profit organizations, charities and government agencies which actively carry out social welfare schemes and/or programs to generate social good. The implementers use funds received from funders to organize social good initiatives by acquiring resources and employing people.

The implementers routinely give assistance to those in need in terms of money, materials, time, volunteer support, technical assistance, religious guidance, emotional comfort, safe heaven and counseling. Implementers includes all sorts of entities, for example those which aid in areas such as education, religious programs, health care, international support, peace efforts, homeless, abuse prevention, disaster relief, veteran programs, historical preservation, youth development, arts, wildlife and environment. Finally, objects or recipients, for example, the object 136 include individuals, families and entities, for example, a small business in need that receives benefits of social welfare schemes and/or programs carried out by the implementers.

A person skilled in the art will understand that a funder, for example the funder 124 could be an individual or an entity. In case the funder 124 is not an individual (i.e. the funder 124 is an entity), a funder agent, such as an employee, contractor or an authorized representative of the funder 124 will access and utilize the OSDS 102. Similarly, the implementer 132 could also be an individual or an entity. In case the implementer 132 is not an individual (i.e. the implementer 132 is an entity), an implementer agent, such as an employee, contractor or an authorized representative of the implementer 132 will access and utilize the OSDS 102 on behalf of the implementer 132.

In an embodiment, the funder 124, the funder 126, and the funder 128 accesses the OSDS 102 by using the client device 104, client device 108 and the client device 108 respectively. Similarly, the implementer 130, the implementer 132, the implementer 134 accesses the OSDS 102 by using the client device 110, client device 112 and the client device 114 respectively. Finally, an object, for example the object 136, the object 138 and the object 140 accesses the OSDS 102 by using client device 116, client device 118 and the client device 120 respectively. Typically, an object, for example, the object 136, is an individual, member of family or an entity, for example, a business that is recipient of benefits of a social welfare scheme and/or program. In case the object 136 is an entity, an authorized representative of the object 136, for example an owner, employee or contractor of the object 136 will access the OSDS 102 by utilizing the client device 116.

Embodiments described herein also include physical and other computer-readable media for carrying or storing computer-executable instructions and/or data structures. Such computer-readable media can be any available media that can be accessed by a general purpose or special purpose computing system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: storage media and transmission media.

Computer-readable storage media includes RAM, ROM, EEPROM, CD-ROM or other optical disk storage, magnetic disk storage or other magnetic storage devices, or any other physical and tangible storage medium which can be used to store desired program code means in the form of computer-executable instructions or data structures and which can be accessed by a general purpose or special purpose computing system.

In an embodiment, “network” is defined as one or more data links that enable the transport of electronic data between computing systems and/or modules and/or other electronic devices. When information is transferred or provided over a network or another communications connection (either hardwired, wireless, or a combination of hardwired or wireless) to a computing system, the computing system properly views the connection as a transmission medium. Transmissions media can include a network and/or data links which can be used to carry desired program code means in the form of computer-executable instructions or data structures and which can be accessed by a general purpose or special purpose computing system. Combinations of the above should also be included within the scope of computer-readable media.

Further, upon reaching various computing system components, program code means in the form of computer-executable instructions or data structures can be transferred automatically from transmission media to storage media (or vice versa). For example, computer-executable instructions or data structures received over a network or data link can be buffered in RAM within a network interface module (e.g., a “NIC”), and then eventually transferred to computing system RAM and/or to less volatile storage media at a computing system. Thus, it should be understood that storage media can be included in computing system components that also (or even primarily) utilize transmission media.

Computer-executable instructions comprise, for example, instructions and data which, when executed at a processor, cause a general-purpose computing system, special purpose computing system, or special purpose processing device to perform a certain function or group of functions. The computer executable instructions may be, for example, binaries or even instructions that undergo some translation (such as compilation) before direct execution by the processors, such as intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments including cloud with many types of computing system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, datacenters, wearables (such as glasses) and the like. The invention may also be practiced in distributed system environments where local and remote computing systems, which are linked (either by hardwired data links, wireless data links, or by a combination of hardwired and wireless data links) through a network, both perform tasks. In a distributed system environment, program modules may be located in both local and remote memory storage devices.

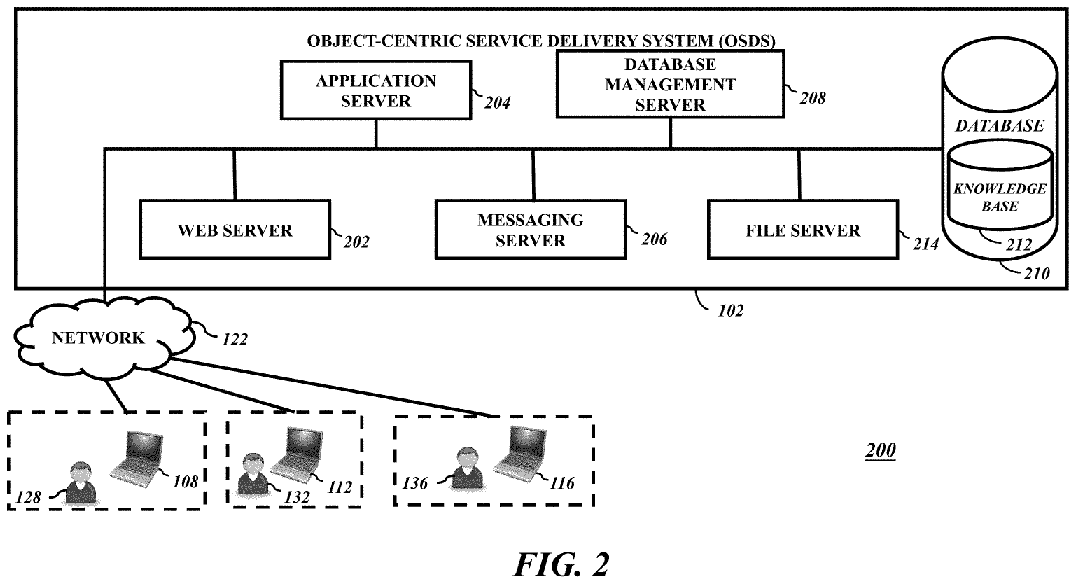

FIG. 2 is a block diagram that illustrates an environment 200 where various embodiments of the present invention may be practiced. The environment 200 includes the OSDS 102, a plurality of client devices, for example, the client device 104, the client device 112 and the client device 116. Each client device of the plurality of client devices are connected to the OSDS 102 via the network 122. The funder 128 accesses the OSDS 102 through the client device 108, the implementer 132 accesses the OSDS 102 through the client device 112, and the object 136 accesses the OSDS 102 through the client device 116.

In an embodiment, the OSDS 102 includes a web server 202, an application server 204, a messaging server 206, a database management server 208; which is used to manage at least a database 210, the database 210 including a knowledgebase 212, and a file server 214. In an embodiment, one of more servers can be implemented as a single server.

The web server 202 may communicate with the file server 214 to publish or serve files stored on the file server 214. The web server 202 may also communicate or interface with the application server 204 to enable web-based presentation of information. For example, the application server 204 may consist of scripts, applications, or library files that provide primary or auxiliary functionality to the web server 202 (e.g., multimedia, file transfer, or dynamic interface functions). In addition, the application server 204 may also provide some or the entire interface for the web server 202 to communicate with one or more of the other servers in the OSDS 102, e.g., the messaging server 206 or the database management server 208.

In an embodiment, the application server 204 provides access to business logic for use by applications running on the plurality of client devices, for example, the client device 108, the client device 112 and the client device 116. An application can use the business logic just as it would call a method (or a function). These applications not only include applications running on the client device, but also on a Web server, or even other application servers. In an embodiment, the application server 204 creates the plurality of OSDS containers. An OSDS container corresponding to a financial asset. The OSDS container including a financial asset value, a plurality of attributes and a set of rules that the financial asset is required to comply with. In an embodiment, the application server 204 creates the integrated OSDS container from one or more OSDS containers. The integrated OSDS container is configured to service the request for the financial aid. The integrated OSDS container including a financial aid value, and a set of rules for utilizing the financial aid.

The financial aid could be a donation, a grant, an aid, a bequest, a gift, a scholarship, a charitable donation, a loan or any other kind of cash or non-cash assistance provided by the funder. Examples of non-cash financial aid include, but are not limited to stocks, real estate, clothing, furniture, household items, wine collections, art, jewelry, antiques, collectibles, automobiles, boats and recreational vehicles. In some embodiments, the financial aid could flow from a contractual arrangement between the funder and the implementer. Typically, financial aid could be a monetary reward in exchange of something. For example, a pet shelter may share information about those who have adopted pets to a pet food company. The pet food company may use to the information for targeted advertisement and promotion of its products. When the owner of the pet purchases products from the pet food company, the pet food company may provide a monetary reward to the pet shelter. In this example, the pet food company is a funder, the monetary reward is the financial aid and the pet shelter is the implementer.

Typically, the set of rules for utilizing the financial aid are based on the set of rules of the one or more OSDS containers. In an embodiment, the integrated OSDS container also includes at least one regulation. The regulation comprises at least one of a legislative regulation, an established standard, and a policy.

In an embodiment, the application server 204 also provides a platform to create, manage, and administer the plurality of objects, funders and implementers. The application server 204 also provides the platform that enables the funders and implementers to manage, track and administer their compliance requirements.

The database 210 may include data to manage the plurality of objects, individualized information associated with the object, data about a plurality of funders, implementers, and social welfare programs and schemes. In an embodiment, the databases 210 stores the plurality of OSDS containers. An OSDS container corresponds to a financial asset and includes a financial asset value, a plurality of attributes and a set of rules that the financial asset is required to comply. The database 210 also stores the integrated OSDS container. In an embodiment, for each funder, the database 210 also stores at least one regulation that the integrated OSDS container is required to comply with. The regulation includes at least one of a legislative regulation, an established standard, and a policy. The database 210 may be a relational database, a centralized database, a distributed database, an object-oriented database, a cloud-based database, a flat database or any other structure in accordance with a selected embodiment. A “data repository”, “database”, “knowledgebase” and “data warehouse”, as used herein, are considered interchangeable, and may be relational, object-oriented, object-relational, or use files or flat files, or any combinations of the above.

In an embodiment, a user, for example the funder 128, the implementer 132, or the object 136 may interface with the OSDS 102, such as by using the web server 202, to initiate an activity. The activity may include creating a new rule, associating a rule with a financial asset. In an embodiment, the activity may include creating a request for a financial aid. The request for the financial aid including at least one intended use of the financial aid. The activity may also include other types of activities, such as processing, account activation, account access, routine security checks, or surveys etc. A user, for example, an implementer 132 may be presented one or more user-interface elements, such as drop-down lists, check boxes, radio buttons, text input fields, or the like. The user-interface may be implemented using a variety of programming languages or programming methods, such as HTML, VBScript, JavaScript, XML, XSLT, AJAX, Java, and Swing. In various embodiments, the OSDS 102 may provide a variety of interfaces and applications for the agents and/or the objects, which may be defined using the application server 204. In an embodiment, the user-interface can be accessed from a mobile device, such as a mobile phone, smartwatch etc. by using a mobile application.

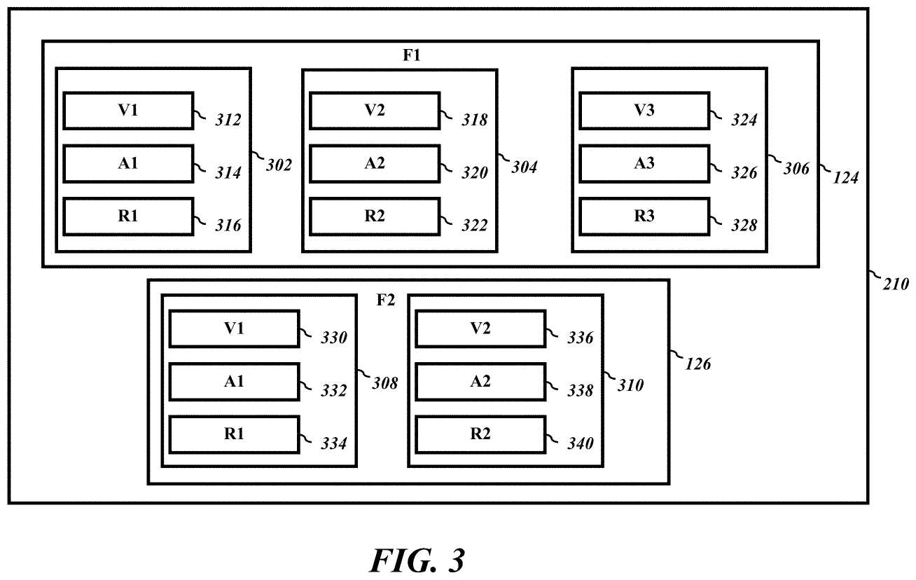

FIG. 3 is a block diagram illustrating the exemplary database 210 in accordance with an embodiment of the present invention. The term, “database” as used herein, is same as “data repository” and can be any kind of data storage, for example, relational, object-oriented, object-relational, centralized, distributed, cloud-based database or a flat database in various embodiment or utilize any other structure, in accordance with a selected embodiment.

In an embodiment, the database 210 may be integrated, namely, that the information resides within a singular, co-located or otherwise centralized database structure or schema, or may be a distributed database, with information distributed between and among a plurality of databases, some of which may be remotely located from the other databases. From another point of view, the database 210 may be considered integrated in that a plurality of different tables or types of tables, objects or relations are included within the database 210. Use of any type of data repository, whether an integrated database, a non-integrated database, or any otherwise distributed or non-distributed database structures or schemas, are within the scope of the present invention.

The database 210 is shown to provide a block diagram depicting implementation of various funders, for example, of the funder 124 and the funder 126 on the database 210. Typically, the OSDS 102 implements a funder in form of one or more OSDS containers. For example, the funder 124 has an OSDS container 302, an OSDS container 304, and an OSDS container 306. Similarly, the funder 126 has an OSDS container 308 and an OSDS container 310. Typically, an OSDS container corresponds to a financial asset. Examples of the financial asset can be cash, non-cash, cash-equivalents, securities, investments, equitable interests, real property, personal property, intellectual property, trust, royalties, future income, lottery winnings, and any other asset having value.

Typically, the OSDS container is a software construct. In an embodiment, the OSDS container includes data and one or more processes which, when executed in a computer system, are isolated from other processes running within the computer system. Typically, the data corresponds to the financial asset value. The one or more processes correspond to the set of rules that the financial asset is required to comply with.

In an embodiment, each OSDS container, for example the OSDS container 302 contains an OSDS container agent. Typically, the OSDS container agent is a software application. The OSDS agent, when executed by one or more processors of a computer system, perform various tasks, including registering the OSDS container with a funder, implementer or an object; deregistering the OSDS container; starting a task, stopping a task, providing task status, and reporting a task event. Example of the task include determining if a financial asset complies with the set of rules, establishing relation between one or more OSDS containers, enabling communication between OSDS containers, enabling communication between the implementer and the funder, sending request for financial aid, providing financial aid, generating an integrated OSDS container and so forth.

The OSDS container includes a financial asset value, a plurality of attributes and a set of rules. The financial asset is required to comply with the set of rules. For example, for the funder 124, the OSDS container 302 includes a financial asset value 312, a plurality of attributes 314 and a set of rules 316. The OSDS container 304 includes a financial asset value 318, a plurality of attributes 320 and a set of rules 322. The OSDS container 306 includes a financial asset value 324, a plurality of attributes 326 and a set of rules 328. Similarly, for the funder 126, the OSDS container 308 includes a financial asset value 330, a plurality of attributes 332 and a set of rules 334. The OSDS container 310 includes a financial asset value 336, a plurality of attributes 338 and a set of rules 340.

In an embodiment, a financial asset value, for example the financial asset value 312 is a monetary value of the financial asset that the funder, for example the funder 124 can derive from the financial asset. In another embodiment, the financial asset value is a monetary value of the financial asset that the funder can provide to one or more implementers. Typically, the financial asset value can be cash value, value of securities, value of investments, value of equitable interests, value of real property, value of personal property, value of intellectual property, value of trust, value of royalties, value of future income, value of lottery winnings or any other value that can be attributed to the financial asset.

In an embodiment, the value of the financial asset is the corresponding value in accordance with generally accepted accounting principles (GAAP). GAAP refers to a common set of accepted accounting principles, standards and procedures that entities and their accountants must follow when they compile their financial statements. GAAP is a combination of authoritative standards set by policy boards and the commonly accepted ways of recording and reporting accounting information and improves the clarity of communication of financial information. For example, the financial asset value of a house could be its current market value, which could be $200,000. Similarly, the financial asset value of 100 equity stocks could be $90,000 and so forth. In an embodiment, the financial asset value is value that can be derived from the financial asset. For example, the financial asset is a house with market value of $900,000. However, the value that the funder is allowed to derive from the house is the rental income of $5000 per month. In this case the financial asset value of the house could be $5000 per month. Similarly, the financial asset value of a set of stocks could be the amount annual dividends issued.

In an embodiment, a plurality of attributes, for example the plurality of attributes 314 include, metadata associated with the financial asset. For example, when the financial asset is cash then an attribute of the plurality of attributes can be, for example, the relevant currency such as United States Dollar, Euro, Yuan, Yen etc. Similarly, another attribute of the plurality of attributes, can be, for example the bank and account details where the cash is stored etc. In another example, when the financial asset is a real estate, the plurality of attributes may include for example, the address, details of any lien or mortgage, ownership details, details of any current or past tenants, any current or past litigation associated with the real estate and so forth. A person skilled in the art will understand that the plurality of attributes will include information about the financial asset that may be useful for someone to use the financial asset. In another embodiment, the plurality of attributes provides details of the kind of projects the funder can support or fund.

The set for rules that the financial asset is required to comply with, for example, the set of rules 316 include details of what can or cannot be done with the financial asset. In some embodiments the set of rules are positive rules which dictates what can be done with the financial asset. For example, the financial asset can only be utilized for purchasing food. In another embodiment, the set of rules can be negative rules providing what should not be done with the financial asset. For example, the financial asset ‘shall not be used for paying salaries.’ In some embodiments, the set of rules are broad, for example, the financial asset ‘shall be used for welfare of the poor’ or that the financial asset ‘shall be used for environment protection’ or the financial asset ‘shall be used for promoting women education’ etc. In these embodiments, the OSDS 102 may generate a set of additional rules and add them to the set of rules.

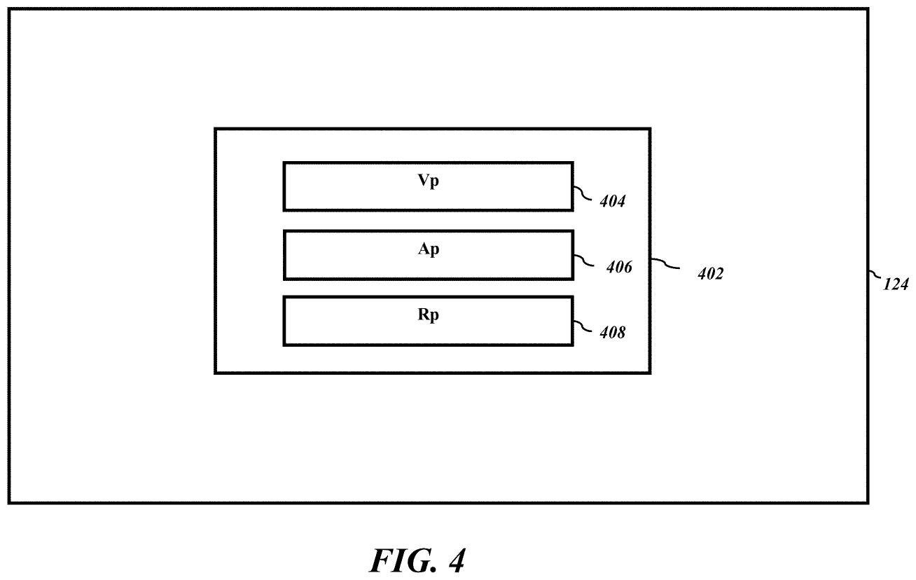

FIG. 4 provides a block diagram depicting the funder 124 in accordance with various embodiments of the present invention. The funder 124 is shown to include a parent OSDS container 402. In an embodiment, the parent OSDS container is created by combining the plurality of OSDS containers of the funder 124. Typically, the parent OSDS container corresponds to a cumulative financial asset. The cumulative financial asset is an aggregation of a plurality of financial assets of the plurality of OSDS containers of the funder 124.

The parent OSDS container 402 includes a parent asset value 404, an integrated set of attributes 406, and an integrated set of rules 408. The parent asset value 404 is the sum of a plurality of financial asset values of the plurality of OSDS containers. For example, for funder 124, the parent asset value 404 is the sum of the financial asset value 312, the financial asset value 318 and the financial asset value 324. For example, the financial asset value 312 is USD 200,000, the financial asset value 318 is USD 400,000 and the financial asset value 324 is USD 200,000. In this example, the parent asset value 404 will be USD 800,000.

The integrated set of attributes 406 is an aggregation of the plurality of attributes of each OSDS container of the plurality of OSDS containers. The integrated set of attributes for the funder 124 includes the aggregation of the plurality of attributes 314, the plurality of attributes 320 and the plurality of attributes 326.

Similarly, the integrated set of rules 408 is the set of rules that the cumulative financial asset is required to comply with. In an embodiment, the integrated set of rules is an aggregation of the set of rules of each OSDS container of the plurality of OSDS containers. For example, the integrated set of rules 408 is an aggregation of the set of rules 316, the set of rules 322 and the set of rules 328.

In an embodiment, the parent OSDS container also includes at least one regulation that the parent OSDS container is required to comply with. The at least one regulation includes at least one of a legislative regulation, an established standard, and a policy.

In an embodiment, the integrated set of rules include a normalized set of rules that the cumulative financial asset is required to comply with. The normalized set of rules are based on a plurality of set of rules of the plurality of OSDS containers. Typically, the normalized set of rules are associated with the parent OSDS container 402.

In an embodiment, the OSDS 102 generates the normalized set of rules. Typically, generating the normalized set of rules includes selecting a first set of rules from the plurality of OSDS containers to be normalized. The selecting includes identifying at least one of from the group comprising one or more duplicate rules, one or more inconsistent rules, one or more overlapping rules, one or more obsolete rules, one or more inapplicable rules, and one or more unlawful rules. Generating the normalized set of rules further includes, selecting one or more normalization rules from a knowledgebase. The knowledgebase is configured to store a plurality of normalization rules. Typically, the knowledgebase resides within the database 210. Finally, generating the normalized set of rules includes applying the one or more normalization rules to the first set of rules. This applying includes, reconciling the one or more duplicate rules, the one or more inconsistent rules, and the one or more overlapping rules. This applying the one or more normalization rules to the first set of rules further includes removing the one or more obsolete rules, the one or more inapplicable rules, and the one or more unlawful rules.

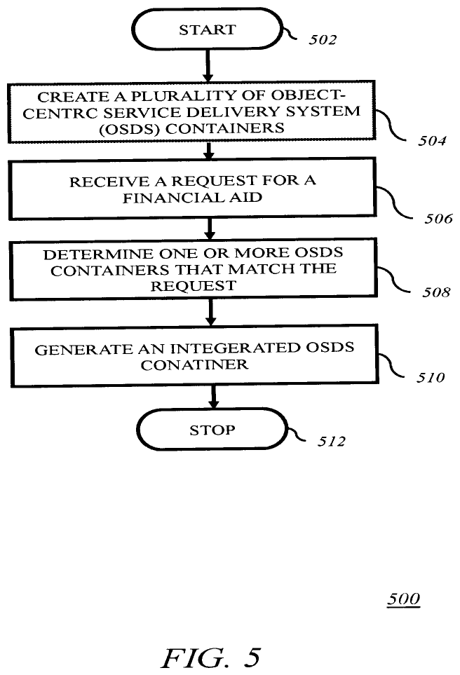

FIG. 5 is a flowchart illustrating an exemplary method 500 for object-centric service delivery according to various embodiments of the present invention. The exemplary method 500 is merely an illustration of an aspect of object-centric service delivery. Other methods and processes are possible, and more or fewer steps of setup may be implemented by the OSDS 102 in various embodiments. To describe the method 500, reference has been made to FIG. 1, FIG. 2, FIG. 3 and FIG. 4, although it should be understood that the method 500 could be implemented in any other suitable environment or network. Moreover, the invention is not limited to the order in which the steps are listed in the method 500. Typically, the method 500 is performed by the OSDS 102.

At step 502, the method for object-centric service delivery is initiated. At step 504 the plurality of OSDS containers are created. Typically, the OSDS 102 creates the plurality of OSDS containers. In an embodiment, each funder, for example the funder 126, the funder 128 and the funder 130 provides information to the OSDS 102 so that the OSDS can create the plurality of OSDS containers. Typically, a funder, for example the funder 124 creates an account with the OSDS 102 in the process of creating the account provides information that is used to create the plurality of OSDS containers.

Typically, the OSDS 102 enables a sign-up process having a plurality of questions for collecting the information. The funder, for example, the funder 124 provides information while creating his funder account with the OSDS 102. In an embodiment, the OSDS 102 provides an intelligent agent that can collect the information of a plurality of funders, for example the funder 124, the funder 126 and the funder 128. Typically, the intelligent agent is powered by AI and engages with the funder 124 in a conversational or Q&A format to collect the information. In an embodiment, the intelligent agent utilizes AI and/or voice inputs to gather the information of the funder 124.

Once the OSDS 102 acquires necessary information from the funders, for example the funder 124, it processes the information and creates the plurality of OSDS containers, for example, the OSDS container 302, the OSDS container 304 and the OSDS container 306.

The funder may include, for example one or more departments of the United States Department of Housing and Urban Development (HUD). HUD is a Cabinet department in the United States Federal Government which develops and executes policies on housing. Each year, HUD awards Homeless Assistance Grants to communities that administer housing and services at the local level. Specifically, the Emergency Solutions Grant (ESG) program and the Continuum of Care (CoC) program of the HUD are the cornerstones of homeless support systems nationwide. The ESG grant funds street outreach, homelessness prevention and diversion, emergency shelter, and rapid re-housing. The CoC program provides financial aid for implementers such as, nonprofit providers, State and local governments to quickly rehouse homeless individuals and families.

The department managing the CoC program can create and account with the OSDS 102 and become a funder, for example, the funder 124. The department managing the CoC program has numerous employees that are responsible. One or more of of these employees can be agents of the CoC i.e. agents of the funder 124 and act and take decisions on behalf of the CoC program. The CoC program has an annual budget and is funded by the US Federal government to carry out its various programs. Eligible applicants of the CoC program consist of nonprofit organizations, State and local governments, instrumentalities of local governments, and public housing agencies. In an embodiment, all these applicants may be implementers, for example the implementer 130, the implementer 132 and the implementer 136 etc.

The CoC program has five program components namely permanent housing, transitional housing, supportive services, Homeless Management Information System (HMIS), and, homelessness prevention. Each of these program components may have a separate budget and can fund eligible applicants by making grants. Thus, each of these program components can have one or more OSDS containers. for example, the permanent housing program can have the OSDS container 302, the homeless prevention can have the OSDS container 304 and so forth.

In an embodiment, the OSDS container, for example the OSDS container 302 corresponds to a financial asset. The OSDS container includes a financial asset value, a plurality of attributes and a set of rules that the financial asset is required to comply with. For example, the OSDS container 406 includes the financial asset value 312, the plurality of attributes 314 and the set of rules 316.

In an example, the OSDS container 302 corresponds to the permanent housing program of CoC and the OSDS container 304 corresponds to the homeless prevention program of the CoC. The portion of annual budget available for implementers, of each of these programs will be the financial asset and the amount of the funds will be the corresponding financial asset value 312 and the financial asset value 318. In this example, the financial asset of the permanent housing program could be $70 Million and for the financial asset of the homeless prevention program could be $145 Million.

Each of these OSDS containers, for example the OSDS container 302 for the permanent housing program and the OSDS container 304 for the homeless prevention program will have a plurality of attributes. In an embodiment, the plurality of attributes provides the eligibility criteria for applicants. For example, the plurality of attributes 314 for the OSDS container 302 (the permanent housing program) can provide geographical areas covered the program, kind of activities covered the program, kind of implementers the program will support, the application process and so forth. Specifically, the plurality of attributes 314 can provide additional details or requirements that the permanent housing program has. For example, any supported program must provide a community-based housing without a designated length of stay in which formerly homeless individuals and families live as independently as possible. Under the permanent housing program, a program participant must be the tenant on a lease (or sublease) for an initial term of at least one year that is renewable and is terminable only for cause. Further, leases (or subleases) must be renewable for a minimum term of one month. The permanent housing program also provides housing search and relocation services and short- and medium-term rental assistance to move homeless persons and families (with or without a disability) as rapidly as possible into permanent housing. In another example, the plurality of attributes 320 for the OSDS container 302 (the homeless prevention program) provide that the homeless prevention program must provide funds for homelessness prevention assistance for individuals and families at risk of homelessness. The services under this program may include housing relocation and stabilization services as well as short- and medium-term rental assistance to prevent an individual or family from becoming homeless. Through this component, implementers may help individuals and families at-risk of homelessness to maintain their existing housing or transition to new permanent housing.

Each OSDS container includes a set of rules. For example, the OSDS container 302 includes a set of rules 316 and the OSDS container 304 includes the set of rules 322. The set for rules includes rules that the financial asset is required to comply with. In an embodiment, the set of rules are tied to the financial asset and any party (funder, implementer or object) that receives a portion of the financial asset is required to comply with the set of rules for the received portion of the financial asset. Typically, the set of rules 316 include details of what can or cannot be done with the financial asset. In an example, the set of rules 316 of OSDS container 302 (permanent housing program) include a first rule that acquisition of real property is an eligible cost category and grant funds may be used for up to 100 percent of the cost of purchasing property. The set of rules 316 include a second rule that rehabilitation of structures is an eligible cost category and that eligible rehabilitation costs include installing cost-saving energy measures and bringing a structure up to health and safety standards. The set of rules 316 includes a third rule that recipients and subrecipients may use up to 10 percent of the grant as administrative cost. Finally, the set of rules 316 also includes a fourth rule that operating cost such as maintenance, repair, building security, electricity, gas, water, furniture, equipment, property insurance, and taxes are eligible expenses.

In an embodiment, the set of rules, for example, the set of rules 316 can be negative rules specifying what should not be done with the financial asset. For example, the set of rules 316 for the OSDS container 302 (permanent housing) may include a fifth rule that the purchase of equipment, fixtures, motor vehicles, furnishings, or other personal property not an integral structural fixture is ineligible. The set of rules 316 also may include a sixth rule that funds should not be spent for income payment, for example, for food, clothing etc. Finally, the set of rules 316 may also include a seventh rule that funds shall not be used to finance the use of facilities or equipment for political purposes or to engage in other partisan political activities, such as candidate forums, voter transportation, or voter registration.

In an embodiment, the set of rules, for example the set of rules 316, includes at least one of a set of primary rules and set of secondary rules. Typically, the set of primary rules must be complied by a recipient of the financial aid. In an embodiment, the set of secondary rules must be complied but may be relaxed in certain situations. Typically, the set of secondary rules may be relaxed when the recipient, for example, the implementer and/or the object obtains approval from the funder.

At step 506 the request for a financial aid is received. Typically, the OSDS 102 receives the request for the financial aid. In an embodiment, the request for the financial aid includes at least one intended use of the financial aid. Typically, the request is from an implementer or an object in need of financial aid, for example the implementer 132 or the object 136. In an example, the request for financial aid from the implementer 132 is for a sum of $300,000 for providing shelter for the homeless in the city of San Francisco. Typically, the request for the financial aid may specify criteria for the funder. Based on the criteria the OSDS 102 may determine one or more funders to which the request for the financial aid is to be send.

In another embodiment, the request for the financial aid specifies at least one funder to which the request is to be sent by the OSDS 102. In an embodiment, the OSDS 102 enables automated matching of a funder and an implementer. The implementer need not know the identity of the funder before submitting the request for the financial aid. The implementer can just summit a request for a financial aid and the OSDS 102 identifies one or more funders that may serve the request for financial aid. This relieves the implementer from the administrative burden of identifying funders. The OSDS 102 already has details of the implementer and it can use the details to prepare the request for the financial aid and determine the appropriate funders to send this request. Similarly, the OSDS 102 may relieve the administrative burden of the funder as well by forwarding only those requests for financial aid that can be served by the funder.

In an embodiment, the request for financial aid enables creation of a dynamic relation between an implementer and a funder and thereby a faster turnaround time. If an implementer, for example, the implementer 132 encounters a short term or an immediate need of financial aid for a specific program, for example for serving food for the homeless wherein more than the expected homeless individuals have signed up for a particular day, the implementer can create a request for financial aid and immediately send it to one or more funders. If a funder agrees to service the request for financial aid then additional homeless individuals can be served food through this additional financial aid. The OSDS 102 enables efficient and runtime handling of the request for financial aid.

In an embodiment, a funder, for example, the funder 124 may send a request for proposal (RFP) to a plurality of potential implementers, the RFP requesting submission of one or more proposals seeking financial aid. In an embodiment, the funder 124 sends the RFP to one or more potential objects. Once these potential implementers and/or objects receive the RFP some of them may respond by sending a response in form of a request for a financial aid. This request for financial aid is then received by the OSDS 102.

At step 508, one or more OSDS containers are determined that match the request for the financial aid. Typically, the OSDS 102 determines one or more OSDS containers of the plurality of OSDS containers that match the request for the financial aid. In an embodiment, each funder that has received the request for the financial aid determines the one or more OSDS containers of the plurality of OSDS containers that match the request for the financial aid. In an embodiment, this match is based on at least one of from the group including the at least one intended use of the financial aid, the financial asset value and the set of rules that the financial asset is required to comply with.

Typically, the request for the financial aid includes the intended use of the financial aid. For example, a request for financial aid from implementer 132 includes the intended use of ‘providing vocational training for the poor in San Francisco in 2019’. Similarly, a request from the implementer 134 may include an intended use of ‘providing homeless shelter in city of San Francisco from May-Aug in 2019’. Typically, the OSDS 102 may receive multiple requests for financial aid from an implementer.

In an embodiment, the OSDS 102 uses AI techniques to determine the one or more OSDS containers of the plurality of OSDS containers that match the request. There are many approaches that fall under the broad umbrella of AI. Some examples include neural networks, rule-based systems, machine learning, deep learning and genetic algorithms. Typically, rule-based systems utilize automatic rule inference, such as rule-based machine learning to develop rules. An example of a rule-based system is the domain specific expert system, such as a medical diagnostic system that uses rules to make deductions or choices. These rule-bases systems are generally suited for structured domains where there are general and well accepted methodologies. Neural networks and genetic algorithms on the other hand use a different approach. They need to be trained on a data set from which they derive patterns. Genetic algorithms are generally better suited for unstructured domains. Genetic algorithm-based AI systems guide the user by enhancing their judgment, rather than replacing them.

Typically, the OSDS 102 matches the request for the financial aid based on a match between the intended use of the financial aid and the set of rules of each OSDS container that the financial asset is required to comply with. For example, when the at least one intended use of the financial aid is to providing homeless shelter in city of San Francisco from May-Aug in 2019 and, for OSDS container 302 the set of rules that the financial aid is required to comply with include a rule “the financial aid is to be used only for providing health related services for the poor” then there is no match between the request for the financial aid and the set of rules that the financial aid is required to comply with. However, in another example, the set of rules that the financial aid is required to comply with includes “the financial aid is to be used for the welfare of the poor in the state of California.” In this case there is a match. Thus, the OSDS 102 provides an intelligent matching of the request of the financial aid with one or more OSDS containers. This matching is more than simple text-based matching and is powered by AI. Typically, determining the one or more OSDS containers that match the request is powered by AI algorithms implemented by the OSDS 102. In another embodiment, determining the one or more OSDS containers is keyword or text-based matching.

At step 510, the method 500 generates an integrated OSDS container from the one or more OSDS containers. The one or more OSDS containers match the request for the financial aid. In an embodiment, the integrated OSDS container is an OSDS container in which data is physically stored in separate files that are linked to each other. In an embodiment, the separate filed are connected through logical connectors. In an embodiment, the integrated OSDS container is configured to service the request for the financial aid. The integrated OSDS container includes a financial aid value, and a set of rules for utilizing the financial aid. The set of rules for utilizing the financial aid are based on the set of rules of the one or more OSDS containers. In an embodiment, generating the integrated OSDS container includes determining a financial aid value. Generating the integrated OSDS container further includes creating a set of rules for utilizing the financial aid. The set of rules for utilizing the financial aid are based on the set of rules of the one or more OSDS containers.

Typically, the OSDS 102 analyses the set of rules of the one or more OSDS containers and identifies the rules that are common across the one or more OSDS containers. In an embodiment the OSDS 102 also identifies the rules that are unique to an OSDS container of the one or more OSDS containers. Once this commonality and the uniqueness is identified the OSDS 102 creates the set of rules for utilizing the financial aid by aggregating the rules that are common and the rules that are unique to create the set of rules for utilizing the financial aid. From an implementer or an object perspective, tracking and complying with the set of rules for utilizing the financial aid are less complex compared to tracking and complying with the set of rules of the one or more OSDS containers.

In an embodiment, creating the set of rules for utilizing the financial aid includes selecting a second set of rules from the one or more OSDS containers to be normalized. The selecting includes identifying at least one of from the group including one or more duplicate rules, one or more inconsistent rules, one or more overlapping rules, one or more obsolete rules, one or more inapplicable rules, and one or more unlawful rules. Creating the set of rules for utilizing the financial aid further includes selecting one or more normalization rules from the knowledgebase. Typically, the knowledgebase resides in the database 210 and is configured to store a plurality of normalization rules. Creating the set of rules for utilizing the financial aid also includes applying the one or more normalization rules to the second set of rules. The applying includes reconciling the one or more duplicate rules, the one or more inconsistent rules, and the one or more overlapping rules. The applying further includes removing the one or more obsolete rules, the one or more inapplicable rules, and the one or more unlawful rules. Thereafter, the financial aid value and the set of rules for utilizing the financial aid are associated with the integrated OSDS container.

Typically, the set of rules for utilizing the financial aid is an aggregation of set of rules of the one or more OSDS containers. In an embodiment, the set of rules for utilizing the financial aid must be complied by a recipient or a potential recipient of the financial aid. In an embodiment, the set of rules for utilizing the financial aid must be followed by a recipient of the financial aid to certify that the recipient of the financial aid is in compliance.

Typically, the OSDS 102 provides a Graphical User Interface (GUI) that graphically depicts and enables configuring at least one of the plurality of OSDS containers, and the integrated OSDS container. Typically, an agent of the funder can configure an OSDS container and the integrated OSDS container. In an embodiment, the integrated OSDS container also includes at least one regulation that the integrated OSDS container is required to comply with. The at least one regulation includes at least one of a legislative regulation, an established standard, and a policy.

In an exemplary embodiment, the OSDS 102 may determine that the OSDS container 302, the OSDS container 306 and the OSDS container 310 match the request for a financial aid from the implementer 132. Once such a match is identified, the OSDS 102 will create an integrated OSDS container to service this request for the financial aid. In this example, the integrated OSDS container will have a financial aid value, and a set of rules for utilizing the financial aid. The set of rules for utilizing the financial aid are based on the set of rules 316, the set of rules 328 and the set of rules 340. In an embodiment, the set of rules for utilizing the financial aid is an aggregation of the set of rules 316, the set of rules 328 and the set of rules 340. For example, the request for financial aid was for $500,000 and the intended use of the financial aid was to provide shelter for the homeless in San Francisco. The OSDS 102 determines that the OSDS container 302, the OSDS container 306 and the OSDS container 310 match the request. Thereafter, an integrated OSDS container is created. The integrated OSDS container includes a financial asset value of $500,000 where $200,000 is from the OSDS container 302, $150,000 is from the OSDS container 306 and $150.00 is from the OSDS container 310. The integrated OSDS container has a set of rules for utilizing the financial aid. The set of rules for utilizing the financial aid is an aggregation of the set of rules 316, the set of rules 328 and the set of rules 340. In this example, the set of rules 316 includes a rule that ‘no money should be spent on new construction on leased property’. Also, the set of rules 328 includes a rule that the money should only be spent only on day to day operating cost of the housing unit, including maintenance, repair, electricity, gas, water, furniture, equipment, property insurance and taxes. In this example, the set of rules for utilizing the financial aid will include a rule that the funds from the OSDS container 302 ($200,000) will not be spent on new construction on leased property and that another rule that the funds from the OSDS container 306 ($150,000) will only be spend on the day to day operating cost of the housing units.

In embodiment, the integrated OSDS container is sent to a recipient of the financial aid. The recipient of the financial aid could be an implementer or an object. In embodiment, the integrated OSDS container is sent to a potential recipient of the financial aid. The potential recipient of the financial aid could be an implementer or an object. In this embodiment, the potential recipient, for example, the implementer 134 analyzes the integrated OSDS container and determines if the implementer 134 is capable of compiling with the set of rules for utilizing the financial aid. In case the potential recipient determines that it cannot comply with the set of rules for utilizing the financial aid that the potential recipient may decline accepting the financial aid.

In an embodiment, the set of rules for utilizing the financial aid is at least one of a set of primary rules and a set of secondary rules. The set of primary rules must be complied by a recipient of the financial aid.

In an embodiment, the OSDS 102 sends that integrated OSDS container to a recipient of the financial aid, for example, the implementer 132 when the OSDS 102 has determined that the set of rules for utilizing the financial aid will be complied by the recipient. Typically, the method also includes, receiving a compliance report from the recipient of the financial aid. The compliance report provides details of any discrepancy in compliance with the set of rules for utilizing the financial aid to the OSDS 102 and to one or more funders who have provided the financial aid.

In an embodiment, the OSDS 102 receives a request to relax a compliance requirement. The request to relax is to modify at least one rule from the set of rules for utilizing the financial aid. Typically, the request to relax is sent by an implementer or an object and is directed to one or more funders. In an embodiment, when the funder determines that the request to relax can be agreed upon it updates the integrated OSDS container by modifying the set of rules for utilizing the financial aid to reflect relaxation of the compliance requirement. Thereafter, the funder sends the integrated OSDS container to at least one of from the group including a recipient of the financial aid and an intended recipient of the financial aid. Typically, the integrated OSDS container has a modified set of rules of utilizing the financial aid and the modified set of rules are based on the relaxed compliance requirement.

In another embodiment, on receiving the request to relax a compliance requirement, the funder can send an approval to relax. Upon receipt of the approval to relax, the implementer or the object may update the integrated OSDS container by modifying the set of rules for utilizing the financial aid to reflect relaxation of the compliance requirement. Thereafter, the implementer or object may send a notification to the funder informing that it has updated the integrated OSDS container.

In an embodiment, the funder may update the set of rules of utilizing the financial aid. In an embodiment, the funder may add new rules to the set of rules for utilizing the financial aid. In another embodiment, the funder may modify the set of rules for utilizing the financial aid. Typically, the funder updates the rules of utilizing the financial aid due to change in policy or circumstances of the funder. In some embodiments, the update of the set of rules of utilizing the financial aid is triggered by actions or inactions of a recipient of the financial aid. For example, the funder may update the rules for utilizing the financial aid if a recipient of the financial aid, for example the implementer, fails to comply with one or more rules for utilizing the financial aid, violates one or more rules for utilizing the financial aid of one or more funders, fails to send reports of utilization of the financial aid to one or more funders in a timely manner, defaults with obligations, receives negative feedback from one or more objects it serves, violates a law, regulation or policy etc. Typically, the funder may send a notification to one or more implementers for updating the set of rules for utilizing the financial aid. Upon receipt of the notification, the one or more implementers update their corresponding integrated OSDS container to reflect this change in their set of rules for utilizing the financial aid.

In another embodiment, the funder updates the integrated OSDS container by changing the set of rules for utilizing the financial aid. Thereafter, the funder sends the updated integrated OSDS container to at least one of from the group including a recipient of the financial aid and an intended recipient of the financial aid. Typically, the integrated OSDS container has an updated set of rules of utilizing the financial aid that the recipient and the potential recipient of the financial aid must comply with.

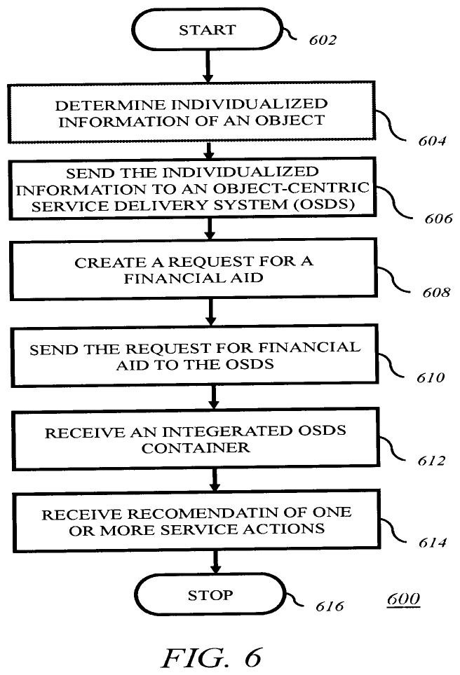

FIG. 6 is a flowchart illustrating an exemplary method 600 for object-centric service delivery according to various embodiments of the present invention. The exemplary method 600 is merely an illustration of an aspect of object-centric service delivery. Other methods and processes are possible, and more or fewer steps of setup may be implemented by the OSDS 102 in various embodiments. To describe the method 600, reference has been made to FIG. 1, FIG. 2, FIG. 3 and FIG. 4, although it should be understood that the method 600 could be implemented in any other suitable environment or network. Moreover, the invention is not limited to the order in which the steps are listed in the method 600. Typically, the method 600 is performed by a client device, for example the client device 120.

At step 602, the method for object-centric service delivery is initiated. At step 604 the individualized information of an object, for example, object 140 is determined. Typically, the object is from a plurality of objects.

In an embodiment, each object of the plurality of objects provide their individualized information to the OSDS 102 while an object account is created with the OSDS 102. Typically, the OSDS 102 enables a sign-up process having a plurality of questions for collecting the individualized information. The object, for example, the object 140 provides the individualized information while creating his object account. In an embodiment, the OSDS 102 provides an intelligent agent that can collect the individualized information of the object 140. Typically, the intelligent agent is powered by AI and engages with the object 140 in a conversational or Q&A format to collect the individualized information of the object 140. In an embodiment, the intelligent agent runs on the client device 120 and utilizes AI and/or voice inputs to gather the individualized information of the object 140.

The individualized information includes one or more performance parameters. A performance parameter covers a performance area of the object. The performance parameter has a set of performance values. Examples of the performance parameters include, but are not limited to citizenship, correctional, education and skills, employment, entrepreneurial, annual income, health, housing, identification, personal finance, veteran benefit, and size of household, residence address.

In an embodiment, the performance parameter is at least one of from the group comprising an intrinsic parameter, and an extrinsic parameter. Typically, the intrinsic parameters are parameters that are specific to the object, for example ethnicity, income. Typically, the extrinsic parameters are parameters that are external to the object, for example, unemployment rate, labor participation rate, consumer price index, per capita income of the locality, unemployment insurance claims data etc.

In an embodiment, the performance parameter has a set of performance values. Typically, each performance value of the set of performance values is associated with a time-stamp. For example, annual income is a performance parameter that has a set of three performance values: $30,000, $25,700 and $42,000 and three timestamps of Dec. 31, 2015, Dec. 31, 2016 and Dec. 31, 2017 respectively. Similarly, household size is another performance parameter that has the value of 3, 4 and 5 and three timestamp values of 2014, 2015 and 2016. In an embodiment, each of the one or more performance parameter has a normalized value, for example, a numerical value on a scale of 1 to 10 or a percentage value from 0% to 100%.

In an embodiment, the OSDS 102 supplements the individualized information of the object, for example the object 140 based on information from a plurality of third-party entities. Examples of a third-party includes, but is not limited to an implementer, a funder, a government agency, a social security administration agency, a postal agency, a public safety agency, a correctional agency, an insurance agency, a tax agency, an immigration agency, a healthcare provider, a retirement income provider, an education provider, a department of motor vehicles (DMV), a department of veteran affairs, a social media network, a political organization, a religious institution, an employer, and a court.

In an embodiment, the client device creates the individualized information of the object. Typically, creating the individualized information of the object includes monitoring interaction of the object with the OSDS 102. For example, the OSDS 102 can track the prior request for service actions to determine the individualized information. This includes prior search for financial aid, consumed service actions and so forth. This may also include prior interaction of the object with one or more implementers and one or more funders.

In an embodiment, creating the individualized information of the object includes predicting the set of performance values based on one of from the group comprising a trend analysis, a time series analysis, a regression analysis, a frequency distribution analysis, predictive modeling, descriptive modeling, data mining, text analytics, forecasting, and simulation. Typically, the OSDS 102 can predict the individualized information of the object. For example, Jack is 50 years old and has always worked as a janitor, the OSDS 102 can predict that there is a high probability that Jack does not have a college degree.

In an embodiment, method of object-centric service delivery includes enabling the object to register voluntarily with the OSDS 102 via a mobile client device, such as a smartphone or a tablet. This registration enables the OSDS 102 to uniquely identify the mobile client device, and associate the object with the mobile client device. In some embodiments, associating the object with the mobile client device may require an addition authentication, for example, biometric authentication.

Typically, the mobile client device, communicates with the fixed infrastructure of GSM PLMN (Public Land Mobile Network) and is capable of transmission and reception of data over a data-capable bearer service provided by the PLMN. The data-capable bearer service enables the mobile client device to communicate with the OSDS 102 connected to the network 122. Examples of the mobile client device include, but are not limited to smartphones and tablet computers.

In an embodiment, the OSDS 102 receives the individualized information through the mobile client device, such as a smartphone. Typically, the OSDS provides an OSDS agent which is a software application to be installed on the mobile client device. Once the OSDS in installed, the OSDS agent can automatically collect the individualized information of the object and sent the same to the OSDS 102. In some embodiments, the mobile client device may prompt the object to provide permission to share the individualized information. Typically, an object, for example the object 140 interacts with a plurality of implementers and the mobile client device may gather individualized information from these interactions and send it to the OSDS 102. For example, a homeless person may sometimes go to a night shelter provided by the city. When, the homeless person arrives at a night shelter, his mobile client device my automatically send information about the check-in at the night shelter, the time of check in and the location of the night shelter to the OSDS 102. This information can be stored by the OSDS 102 an individualized information of the object.

In an embodiment, determining the individualized information of an object includes determining performance values of at least one performance parameter over a geographical area by a mobile client device, for example, the client device 120. For example, the mobile client device can determine that the object frequently spends his evenings at a particular locality. Typically, the mobile client device is uniquely associated with an object. For example, a smartphone is typically associated with an individual who is the owner of the smartphone. In an embodiment, an object, for example the object 140 can register his/her mobile client device with the OSDS 102. Upon registration, the OSDS 102 establishes a trusted relation with the mobile client device and can start associating the individualized information received from the mobile client device with the object. Typically, the mobile client device encodes the individualized information such that the OSDS 102 can uniquely associate the individualized information with the object. After encoding the individualized information, the mobile client device sends the performance values to the OSDS via a mobile radio infrastructure.

In an embodiment, the mobile client device provides the location of the mobile client device to the OSDS 102. Typically, the mobile client device is enabled with a Global Positioning System (GPS) functionality to determine the location information. Typically, the location is provided at periodic intervals. In an example, the mobile client device gathers the location information at interaction of the object with an implementer. For example. Joe is a homeless person who is enrolled for a vocational training program, gets food stamps and sleeps in a night shelter. In this example, the OSDS agent on the mobile client device of Joe can keep track of Joe's interaction with and send individualized information to the OSDS 102 for each interaction. Thus, if Joe is missing his training classes then the mobile client device may notify the OSDS 102.

At step 606, the client device sends the individualized information of the object to the OSDS 102. In an embodiment, the client device, for example the client device 120 has a pre-established trust relation with the OSDS 102 such that the OSDS 102 can uniquely identify the client device 120. In an embodiment, the client device also sends identification and/or authentication information of the object 140 so that the OSDS 102 can associate the individualized information with the object 140. In an embodiment, the client device also sends details of one or more OSDS containers to the OSDS 102. Typically, the one or more OSDS containers are those that are providing financial aid to the object.

At step 608, a request for a financial aid is created. Typically, the request of the financial aid is created by the object, for example the object 140. The request for the financial aid comprises an intended use of the financial aid, and a financial aid value. Typically, the client device, for example, the client device 120 enables the object 140 to create the request for the financial aid. In an embodiment, the OSDS agent running on the client device provides a Graphical User Interface (GUI) and using the GUI an object can create a request for financial aid. An example of request for financial aid could be a request to clear personal debt, a request to pay for home rent, a request to fund medical expenses, a request to provide food stamps etc. Typically, the OSDS agent is powered by AI and engages with the object 140 in a conversational or Q&A format and enables the object 140 to submit the request for the financial aid using his/her voice commands. In an embodiment, the OSDS agent provides an interface so that the object can provide feedback about the one or more service. Typically, the OSDS agent enables the object to provide feedback about one or more implementers, one or more funders and a financial aid.

Typically, the request for financial aid is from an object in need of financial aid. In an example, the request for financial aid from the object 140 is for a sum of $300 for food stamps in the city of San Francisco. Typically, the request for the financial aid may specify criteria for the funder or the implementer. Based on the criteria the OSDS 102 may determine one or more funders to which the request for the financial aid is to be send.

In another embodiment, the request for the financial aid specifies at least one funder to which the request is to be sent by the OSDS 102.

In an embodiment, the OSDS 102 enables automated matching of an implementer or a funder with the object. The object may not know the identity of the funder or the implementer before submitting the request for the financial aid. The object may just summit a request for a financial aid and the OSDS 102 may determine one or more funders or implementers that may serve the request for financial aid. This relieves the object from the administrative burden of identifying funders and implementer. The OSDS 102 already has details including individualized information of the object and it can use these details to prepare the request for the financial aid and determine the appropriate funder and or implementer to send this request. Similarly, the OSDS 102 may relieve the administrative burden of the funder and the implementer as well by forwarding only those requests for financial aid that can be served by the funder or the implementer.

In an embodiment, the request for financial aid enables creation of a dynamic relation between an implementer and an object and thereby a faster turnaround time. If an implementer, for example, the object 140 encounters a short term or an immediate need of financial aid, for example a need of $500 for a vocational training, the object can create a request for financial aid and immediately send it to the OSDS 102. In an embodiment, the OSDS 102 may identify the location of the object and based on the location identify one of more implementers, e.g. NGOs that can provide the necessary funding for the training or can provide the training in the area and send the details to the object 140. If an implementer is available to service the request for financial aid then the object can be served promptly. The OSDS 102 enables efficient and runtime handling of the request for financial aid.

In an embodiment, a funder, for example, the funder 124 may send a request for proposal (RFP) to a plurality of potential objects, the RFP requesting submission of one or more proposals seeking financial aid. Once these potential objects receive the RFP some of them may respond by sending a response in form of a request for a financial aid.

At step 610 the object, for example the object 140 sends the request for the financial aid to the OSDS 102. In the embodiment, the request for the financial aid includes details of one or more OSDS containers. Typically, the request for financial aid includes the location of the object 140.

At step 612 the object receives an integrated OSDS container. The integrated OSDS container is configured to service the request for the financial aid. The integrated OSDS container includes a financial aid value and a set of rules for utilizing the financial aid. The set of rules for utilizing the financial aid are based on set of rules of one or more OSDS containers. Typically, the OSDS 102 analyses the set of rules of the one or more OSDS containers and identifies the rules that are common across the one or more OSDS containers. In an embodiment the OSDS 102 also identifies the rules that are unique to an OSDS container of the one or more OSDS containers. Once this commonality and the uniqueness is identified the OSDS 102 creates the set of rules for utilizing the financial aid by aggregating the rules that are common and the rules that are unique to create the set of rules for utilizing the financial aid. From an object perspective, tracking and complying with the set of rules for utilizing the financial aid are less complex compared to tracking and complying with the set of rules of the one or more OSDS containers. Details of the creation of the integrated OSDS container has been provided in conjunction with FIG. 5.

In an embodiment, the set of rules for utilizing the financial aid includes a first set of normalized rules. The first set of normalized rules are created by selecting a second set of rules from the one or more OSDS containers. The said selecting includes identifying at least one of from the group comprising one or more duplicate rules, one or more inconsistent rules, one or more overlapping rules, one or more obsolete rules, one or more inapplicable rules, and one or more unlawful rules. Creating the first set of normalized rules further includes, selecting one or more normalization rules from the knowledgebase 212. The knowledgebase 212 is configured to store a plurality of normalization rules. Creating the first set of normalized rules also includes, applying the one or more normalization rules to the second set of rules. The said applying includes reconciling the one or more duplicate rules, the one or more inconsistent rules, and the one or more overlapping rules; and removing the one or more obsolete rules, the one or more inapplicable rules, and the one or more unlawful rules.

In an embodiment, the, the integrated OSDS container is a software construct. In an embodiment, the integrated OSDS container includes data and one or more processes which, when executed in a computer system, for example, in a client device, are isolated from other processes running within the computer system. Typically, the data corresponds to the financial asset value. The one or more processes correspond to the set of rules that the financial asset is required to comply with.

In an embodiment, the integrated OSDS container executes one or more processes. The one or more processes correspond to the set of rules for utilizing the financial aid. The one or more processes, when executed, determine whether a proposed utilization of the financial aid complies with the set of rules of utilizing the financial aid. In an embodiment, the proposed utilization of the financial aid is disallowed or rejected when the proposed utilization of the financial aid does not comply with the set of rules of utilizing the financial aid. For example, when the financial aid is for purchase of food and the object attempts to buy alcohol then the proposed utilization is disallowed.

In an embodiment, the proposed utilization of the financial aid is rejected when the object could not be authenticated for the proposed utilization of the financial aid. Typically, the authentication is a biometric authentication, for example, facial, voice, or iris recognition. In an embodiment, the method further includes receiving an incentive, wherein the incentive is designed to encourage a desired behavior. For example, a young student may be receiving a financial aid for her education. In this example, an implementer may provide an incentive that if the object i.e. the student gets a GPA to B+ then she will get a new laptop. Information about such incentives can be provided to the object through the OSDS agent.

At step 614 recommendation of one or more service actions is received. Typically, the object, for example the object 140 receives the recommendation of the one or more service actions. The one or more service actions facilitate the object in attaining the desired state. Examples of a service action include, but are not limited to, proving vocational training, education, skill training, food, shelter, healthcare, daycare, child support. In an embodiment, the desired state of the object is a state where the object is, for example, financially stable and does not need any financial or other support from the funder or the implementer. In another embodiment, the desired state is a state that is better than the current state of the object. A person skilled in the art will understand that it may take numerous service actions and time before for the object attains the desired state, Typically, the object will move from current state to various intermediate states before it attains a state where it no longer needs or qualifies for a service action.

In an embodiment, prior to recommending the one or more service actions, the OSDS 102 determines one or more candidate service actions. Each candidate service action, once implemented, increases the likelihood of the object attaining the desired state. From the candidate service actions, the OSDS 102 determines one or more feasible service actions based on resource availability. For example, for Jazmine the one or more candidate service actions include providing her financial aid, providing her training, providing her education and providing her home. However, OSDS 102 may determine that no funding is available for training. In this case, providing training will not be a feasible service action and the other three candidate service actions are feasible service actions. In the embodiment, after determining the feasible service actions, the OSDS 102 implements an optimization procedure to select the one or more service actions from the one or more feasible service actions. In an embodiment, the OSDS 102 may consider the plurality of objects, and based on optimization procedure and the availability of resources may select the one of more service actions from the one or more feasible service actions.

In an embodiment, the OSDS 102 provides the one or more service actions in the form of a decision tree to the object, for example, the object 140. Typically, the decision tree is displayed on the client device, for example the client device 120. The decision tree includes one root node, one or more sub-nodes and a plurality of leaf-nodes. The service action corresponds to the root node, one or more anticipated service actions correspond to the one or more sub-nodes and a plurality of future states of the object correspond to the plurality of leaf nodes. Thus, the OSDS 102 presents a Graphical User Interface (GUI) to a user, for example to the funder, the implementer or the object to simulate and view how the state of the object will change on application of a plurality of service actions.

In an embodiment, the OSDS 102 provides each service action of the one or more service actions in the form of a decision tree. The decision tree includes one root node, one or more sub-nodes and a plurality of leaf-nodes. The service action corresponds to the root node, one or more anticipated service actions correspond to the one or more sub-nodes and a plurality of future states of the object correspond to the plurality of leaf nodes. Thus, the OSDS agent presents a Graphical User Interface (GUI) to a user, for example to the object 140 to simulate and view how the state of the object will change on application of a plurality of service actions. The GUI provided by the OSDS agent enables the object in planning on how and what service actions to avail.

In an embodiment, the recommendation of the one or more service actions is based on an analysis of the individualized information of the object and individualized information of other objects that are contextually related to the object. The other objects are from the plurality of objects. In an embodiment, the analysis includes at least one of from the group comprising a trend analysis, a time series analysis, a regression analysis, a frequency distribution analysis, predictive modeling, descriptive modeling, data mining, text analytics, forecasting, and simulation.

In an embodiment, the OSDS 102 analyses the individualized information of the plurality of objects. Typically, the analysis is performed by utilizing AI or machine learning techniques. In an embodiment, the OSDS 102 creates a model for predicting the future state of the object based on this analysis. For example, the OSDS 102 can predict the future state of Jazmine who is 35 years old Caucasian, a single mother of children aged 6, 8 and 11 years. Jazmine has not passed high school and recently has been diagnosed with cancer and has since lost her job. In this example, the OSDS 102 may predict that in the near future Jazmine, for example, will not be able to pay her rent and likely become homeless. In an embodiment, this prediction of the future state of Jazmine is based on the analysis of the individualized information of the plurality of objects. In another embodiment, this prediction of the future state of Jazmine is based on the analysis of the individualized information of the plurality of objects that are contextually related to Jazmine.

In an embodiment, the OSDS 102 processes the individualized information of the plurality of objects and identifies the object that are contextually related to the object. Typically, the analysis is performed by utilizing AI or machine learning techniques. The other objects that are contextually related to the object are those that are or were at some point of time in similar situation as the object. For example, Jazmine is 35 years old, is a single parent and has three kids of age 6, 8 and 11 years. Jazmine is of Caucasian ethnicity. She has not passed high school and recently has been diagnosed with cancer and has since lost her job. Based on this individualized information of the object, for example of Jazmine, the OSDS 102 can identify other objects that are contextually related to her. For example, the OSDS 102 identifies Raven. Raven is also of African American ethnicity. When Raven was 37 years old, she was a single parent of three kids of age 5, 9 and 12 years. She was also a high school dropout and was then diagnosed with some major illness and had lost her job. The OSDS 102 also identifies Isabela. Isabela is of Hispanic ethnicity. When Isabela was 33 years old, she had four kids of age 3, 5, 9 and 12 years. At that point she had no job and her husband was then recently deported.

In an embodiment, the method of object-centric service delivery includes creating a request for a service action by a mobile client device. Typically, the OSDS agent enables the object, for example, the object 140 to create the request for a service action. Typically, the mobile client device encodes the request of service action such that the OSDS can uniquely associate the request for service action with the object. Thereafter, the mobile client device, sends the request for a service action to the OSDS 102 via a mobile radio infrastructure. The method further includes, providing the OSDS 102 a location of the mobile client device that sends the request for a service action.

In this embodiment, the location of the mobile client device can be used by the OSDS 102 while determining a response to the request for service action. Typically, the OSDS 102 will direct this request for service actions to one or more funders or implementers that can provide service actions in the location of the mobile client device. This brings efficiency in the social welfare ecosystem. For example, a homeless person my send a request to for food to the OSDS 102. Along with the request, the location of the mobile client device, for example the client device 120 is determined using the GPS and the location is shared with the OSDS 102. Based on this location, the OSDS 102 can identify one or more implementers that are in proximity of the location of the mobile client device. Thereafter, the mobile client device receives recommendation of at least one service action, the recommendation being based on the location of the mobile client device. In an embodiment, the object, for example the object 140 selects at least one service action from the one or more service actions. Thereafter the method 600 terminates at step 616.

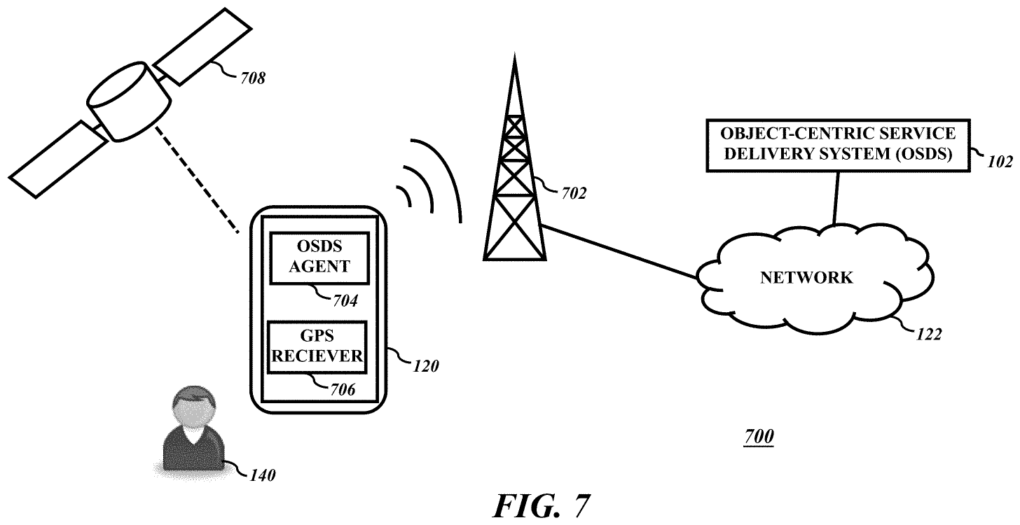

FIG. 7 provides a block diagram depicting the environment 700 of mobile radio infrastructure in accordance with various embodiments of the present invention. The environment 700 is shown to include the OSDS 102, the network 122, the client device 120, and the object 140. In an embodiment, the client device is a mobile client device, such as a smartphone. The client device 120 is capable of establishing a wireless communication with the OSDS 102 via the mobile base station 702. The mobile device 140 has an OSDS agent 704 and a GPS receiver 706. The GPS receiver utilizes the data from a satellite 708 to determine location and time.

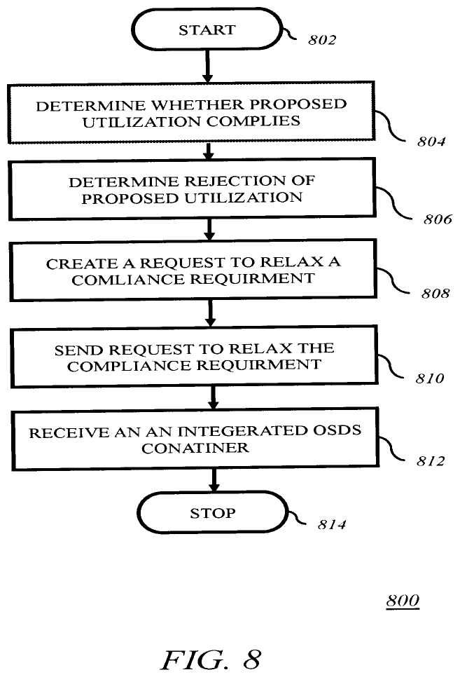

FIG. 8 is a flowchart illustrating an exemplary method 800 for object-centric service delivery according to various embodiments of the present invention. The exemplary method 800 is merely an illustration of an aspect of object-centric service delivery. Other methods and processes are possible, and more or fewer steps of setup may be implemented by the OSDS 102 in various embodiments. To describe the method 800, reference has been made to FIG. 1, FIG. 2, FIG. 3 and FIG. 4, although it should be understood that the method 800 could be implemented in any other suitable environment or network. Moreover, the invention is not limited to the order in which the steps are listed in the method 800. Typically, the method 800 is performed by a client device, for example the client device 120.

At step 802 the method of object centric service delivery for utilizing financial aid is initiated. Typically, the method 800 is executed by a client device, for example the client device 120. At step 804, the client device, for example the client device 120 determines whether a proposed utilization of the financial aid complies with the set of rules of utilizing the financial aid. Typically, the set of rules for utilizing the financial aid is at least one of a set of primary rules and a set of secondary rules. The set of primary rules must be complied by the object.

At step 806 a client device, for example the client device 120, determines rejection of the proposed utilization of the financial aid. Typically, the OSDS agent on the client device determines whether the proposed utilization of the financial aid is complies with the set of rules for utilizing the financial aid. If the proposed utilization for the financial aid does not comply or violate a rule of the set of rules then the OSDS agent rejects the proposed utilization of the financial aid. In another embodiment, the OSDS 102 or one or more OSDS containers determine whether the proposed utilization of the financial aid complies with the set of rules for utilizing the financial aid.

At step 808, a request to relax a compliance requirement is created. Typically, the request to relax the compliance requirement is created by the client device, for example the client device 120. The request to relax is to modify at least one rule from the set of rules for utilizing the financial aid. At step 810, the client device, for example the client device 120 sends the request to relax the compliance requirement to the one or more OSDS containers. Typically, the request to relax the compliance requirement may include a reason why the compliance requirement must be relaxed. Typically, the request to relax the compliance requirement is reviewed by a funder and/or an implementer. In an embodiment, if the request to relax the compliance requirement is to modify or relax a secondary rule the request may be granted. After the request to relax the compliance requirement is granted, at least one of the OSDS 102, the implementer and the funder generates an updated integrated OSDS container. The updated integrated OSDS container includes a modified set of rules for utilizing the financial aid. The modified set of rules for utilizing the financial aid is based on the request to relax the compliance requirement. Thereafter the updated OSDS container is sent to the object 140. At step 812 the client device, for example the client device 120 receives the updated integrated OSDS container. Thereafter, the method 800 terminates at step 814.

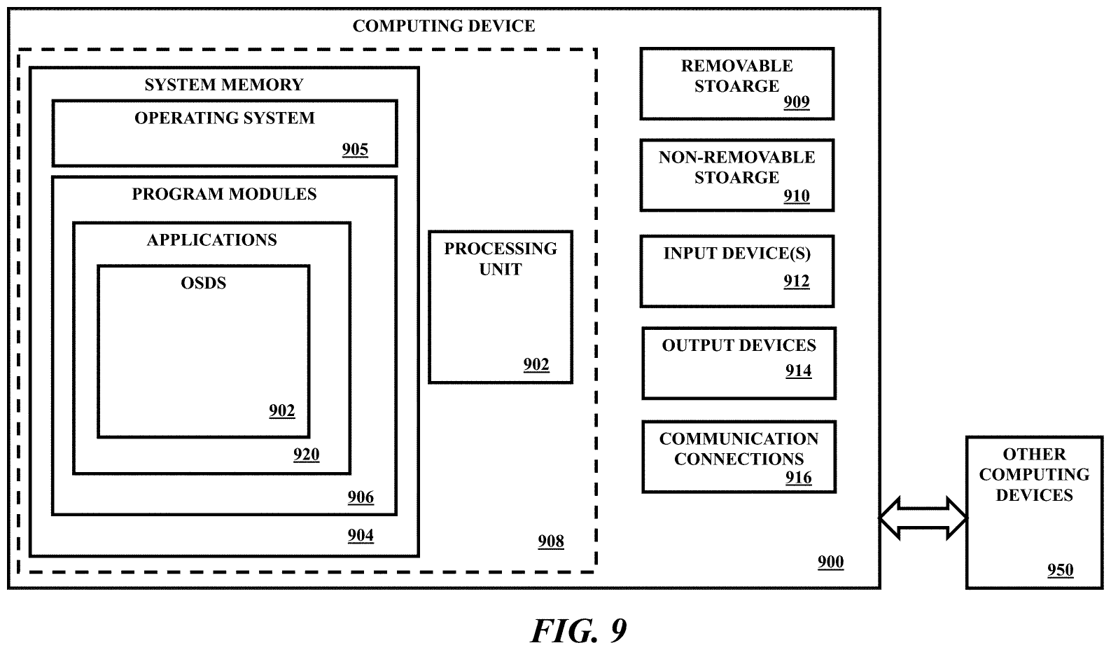

FIG. 9 and the associated descriptions provide a discussion of a variety of operating environments in which aspects of the disclosure may be practiced. However, the devices and systems illustrated and discussed with respect to FIG. 9 is for purposes of example and illustration and are not limiting of a vast number of computing device configurations that may be utilized for practicing aspects of the disclosure, described herein.

FIG. 9 is a block diagram illustrating physical components (e.g., hardware) of a computing device 900 with which aspects of the disclosure may be practiced. For example, the OSDS 102 could be implemented by the computing device 900. In some aspects, the computing device 900 is a personal computer, a desktop computer, a enterprise server, a database server, a storage server, a supercomputer, an artificial intelligent server etc. The computing device components described below may include computer executable instructions for OSDS 102 that can be executed to employ method 400 for object-centric service delivery as disclosed herein. In a basic configuration, the computing device 900 may include at least one processing unit 902 and a system memory 904. Depending on the configuration and type of computing device, the system memory 904 may comprise, but is not limited to, volatile storage (e.g., random access memory), non-volatile storage (e.g., read-only memory), flash memory, or any combined of such memories. In the embodiment, the system memory 904 is remote from the device 900. In an embodiment, the system memory 904 is a cloud-based storage connected to the communication device 900. The system memory 904 may include operating system 905 and one or more program modules 906 suitable for running applications 920. The operating system 905, for example, may be suitable for controlling the operation of the computing device 900. Furthermore, aspects of the disclosure may be practiced in conjunction with a graphics library, other operating systems, or any other application program and is not limited to any particular application or system. This basic configuration is illustrated in FIG. 9 by those components within a dashed line 908. The computing device 900 may have additional features or functionality. For example, the computing device 900 may also include additional data storage devices (removable and/or non-removable) such as, for example, magnetic disks, optical disks, or tape. The additional data storage devices can be remotely located, for example, over a cloud. Such additional storage is illustrated in FIG. 9 by a removable storage device 909 and a non-removable storage device 910. In an embodiment, the individualized information of the plurality of objects, data about funders, data about implementers, the AI models and algorithms could be stored on any of the illustrated storage devices.

As stated above, a number of program modules and data files may be stored in the system memory 904. While executing on the processing unit 902, the program modules 906 (e.g., the OSDS 102) may perform processes including, but not limited to, performing method 400 as described herein. For example, the processing unit 902 may implement the OSDS 102. In an embodiment, the OSDS 102, may include a user interface application, an AI engine, a storage application, a dashboard application, a GUI application, an email application, a social networking application, a collaboration application, a messaging application, a word processing application, a spreadsheet application, a database application, a presentation application, a contacts application, an account management application, a project management application, a finance management application, a gaming application, an e-commerce application, an e-business application, a transactional application, an exchange application, a device control application, a web interface application, a calendaring application, an Enterprise Resource Planning(ERP) application, a Customer Relationship Management (CRM) application, a Supply Chain Management (SCM) application, etc.

Furthermore, aspects of the disclosure may be practiced in an electrical circuit comprising discrete electronic elements, packaged or integrated electronic chips containing logic gates, a circuit utilizing a microprocessor, or on a single chip containing electronic elements or microprocessors. For example, aspects of the disclosure may be practiced via a system-on-a-chip (SOC) where each or many of the components illustrated in FIG. 9 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, may be operated via application-specific logic integrated with other components of the computing device 900 on the single integrated circuit (chip).

Aspects of the disclosure may also be practiced using other technologies capable of performing logical operations such as, for example, AND, OR, and NOT, including but not limited to mechanical, optical, fluidic, and quantum technologies. In addition, certain aspects of the disclosure may be practiced within a general-purpose computer or in any other circuits or systems.

The computing device 900 may also have one or more input device(s) 912 such as a keyboard, a mouse, a pen, a microphone or other sound or spoken language input device, a touch or swipe input device, etc. The output device(s) 914 such as a display, speakers, a printer, etc. may also be included. The aforementioned devices are examples and others may be used. The computing device 900 may include one or more communication connections 916 allowing communications with other computing devices 950. Examples of suitable communication connections 916 include, but are not limited to, RF transmitter, receiver, and/or transceiver circuitry, universal serial bus (USB), parallel, and/or serial ports.

The term computer readable media or storage media as used herein may include computer storage media. Computer storage media may include volatile and nonvolatile, removable and non-removable media implemented in any method or technology for storage of information, such as computer readable instructions, data structures, or program modules. The system memory 904, the removable storage device 909, and the non-removable storage device 910 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 900. Any such computer storage media may be part of the computing device 900. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

In the foregoing specification, the invention and its benefits and advantages have been described with reference to specific embodiments. However, one with ordinary skill in the art would appreciate that various modifications and changes can be made without departing from the scope of the present invention, as set forth in the claims. Accordingly, the specification and the figures are to be regarded in an illustrative rather than a restrictive sense, and all such modifications are intended to be included within the scope of the present invention. The benefits, advantages, solutions to problems, and any element(s) that may cause any benefit, advantage or solution to occur or become more pronounced are not to be construed as critical, required or essential features or elements of any or all the claims. The invention is defined solely by the appended claims, including any amendments made during the pendency of this application, and all equivalents of those claims, as issued.

What is claimed is:

1. A method of object-centric service delivery, the method being executed by at least one processor in a computer system, the method comprising:
determining an individualized information of an object, wherein the object is from a plurality of objects, the individualized information comprising one or more performance parameters, wherein a performance parameter covers a performance area of the object, and wherein the performance parameter has a set of performance values;
sending the individualized information of the object to an object-centric service delivery system (OSDS);
creating a request for a financial aid, the request for the financial aid comprises an intended use of the financial aid, and a financial aid value;
sending the request for the financial aid to the OSDS;
receiving an integrated OSDS container wherein the integrated OSDS container is configured to service the request for the financial aid, wherein the integrated OSDS container comprises a financial aid value and a set of rules for utilizing the financial aid, wherein the set of rules for utilizing the financial aid are based on set of rules of one or more OSDS containers;
receiving recommendation of one or more service actions, wherein the one or more service actions facilitate the object in attaining the desired state, and wherein the recommendation of one or more service actions is based on an analysis of the individualized information of the object and individualized information of other objects that are contextually related to the object, wherein the other objects are from the plurality of objects.

2. The method of object-centric service delivery of claim 1, wherein determining the individualized information of an object comprises:
determining performance values of at least one performance parameter over a geographical area by a mobile client device, wherein the mobile client device encodes the individualized information such that the OSDS can uniquely associate the individualized information with the object, and wherein the mobile client device is associated with the object;
sending the performance values to the OSDS via a mobile radio infrastructure;
providing the OSDS a location of the mobile client device that sends the performance values.

3. The method of object-centric service delivery of claim 1 further comprising:
creating a request for a service action by a mobile client device, wherein the mobile client device encodes the request of service action such that the OSDS can uniquely associate the request for service action with the object;
sending the request for a service action to the OSDS via a mobile radio infrastructure; and
providing the OSDS a location of the mobile client device that sends the request for a service action.

4. The method of object-centric service delivery of claim 3 further comprising receiving recommendation of at least one service action wherein the recommendation is based on the location of the mobile client device.

5. The method of object-centric service delivery of claim 1 further comprising providing an interface so that the object can provide feedback about the one or more service actions.

6. The method of object-centric service delivery of claim 1, further comprising receiving an incentive, wherein the incentive is designed to encourage a desired behavior.

7. The method of object-centric service delivery of claim 1, wherein the set of rules for utilizing the financial aid is at least one of a set of primary rules and a set of secondary rules, wherein the set of primary rules must be complied by the object.

8. The method of object-centric service delivery of claim 1, further comprises:
creating a request to relax a compliance requirement, wherein the request to relax is to modify at least one rule from the set of rules for utilizing the financial aid;
sending the request to relax the compliance requirement to the one or more OSDS containers; and
receiving an updated integrated OSDS container, wherein the updated integrated OSDS container comprises a modified set of rules for utilizing the financial aid, wherein the modified set of rules for utilizing the financial aid is based on the request to relax the compliance requirement.

9. The method of object-centric service delivery of claim 1, wherein the set of rules for utilizing the financial aid comprises a first set of normalized rules, wherein the first set of normalized rules are created by:
selecting a second set of rules from the one or more OSDS containers, wherein the said selecting comprises identifying at least one of from the group comprising one or more duplicate rules, one or more inconsistent rules, one or more overlapping rules, one or more obsolete rules, one or more inapplicable rules, and one or more unlawful rules;
selecting one or more normalization rules from a knowledgebase, wherein the knowledgebase is configured to store a plurality of normalization rules; and
applying the one or more normalization rules to the second set of rules wherein the said applying comprises:
reconciling the one or more duplicate rules, the one or more inconsistent rules, and the one or more overlapping rules; and
removing the one or more obsolete rules, the one or more inapplicable rules, and the one or more unlawful rules.

10. The method of object-centric service delivery of claim 1, further comprises executing one or more processes provided by the integrated OSDS container, the one or more processes correspond to the set of rules for utilizing the financial aid, wherein the one or more processes, when executed, determine whether a proposed utilization of the financial aid complies with the set of rules of utilizing the financial aid.

11. The method of object-centric service delivery of claim 10, further comprises receiving a rejection of the proposed utilization of the financial aid when the proposed utilization of the financial aid does not comply with the set of rules of utilizing the financial aid.

12. The method of object-centric service delivery of claim 11 further comprises receiving a rejection of the proposed utilization of the financial aid when the object could not be authenticated for the proposed utilization of the financial aid.

13. A computer-implementable method of object-centric service delivery executed by at least one processor in a computer system, the computer-implementable method comprising:
creating an individualized information of an object, wherein the object is from a plurality of objects, the individualized information comprising one or more performance parameters, wherein a performance parameter covers a performance area of the object, and wherein the performance parameter has a set of performance values;
sending the individualized information of the object to an object-centric service delivery system (OSDS);
receiving recommendation of one or more service actions from the OSDS, wherein the one or more service actions facilitate the object in attaining the desired state, and wherein the recommendation of one or more service actions is based on an analysis of the individualized information of the object and individualized information of other objects that are contextually related to the object, wherein the other objects are from the plurality of objects; and
selecting at least one service action from the one or more service actions.

14. The computer-implementable method of object-centric service delivery of claim 13, further comprising:
creating a request for a financial aid, the request for the financial aid comprises an intended use of the financial aid, and a financial aid value; and
sending the request for the financial aid to at least one object-centric service delivery system (OSDS) container;

15. The computer-implementable method of object-centric service delivery of claim 14, further comprising receiving an integrated OSDS container, wherein the integrated OSDS container is configured to service a request for financial aid, wherein the integrated OSDS container comprises a financial aid value and a set of rules for utilizing the financial aid, wherein the set of rules for utilizing the financial aid are based on the set of rules of one or more OSDS containers.

16. The computer-implementable method of object-centric service delivery of claim 13, wherein analysis comprises at least one of from the group comprising a trend analysis, a time series analysis, a regression analysis, a frequency distribution analysis, predictive modeling, descriptive modeling, data mining, text analytics, forecasting, and simulation.

17. The computer-implementable method of object-centric service delivery of claim 13 further comprising:
creating a request for a service action by a mobile client device, wherein the mobile client device encodes the request of service action such that the OSDS can uniquely associate the request for service action with the object;
sending the request for a service action to the OSDS via a mobile radio infrastructure; and
providing the OSDS the location of the mobile client device that has sent the request for the service action; and
receiving recommendation of at least one service action wherein the recommendation is based on the location of the mobile client device.

18. The computer-implementable method of object-centric service delivery of claim 13, wherein creating the individualized information of the object comprises monitoring interaction of the object with the OSDS.

19. The computer-implementable method of object-centric service delivery of claim 13, wherein creating the individualized information of the object comprises predicting the set of performance values based on one of from the group comprising a trend analysis, a time series analysis, a regression analysis, a frequency distribution analysis, predictive modeling, descriptive modeling, data mining, text analytics, forecasting, and simulation.

20. A computer program product, comprising:
a computer readable storage medium having program instructions embodied therewith, wherein the computer readable storage medium is not a transitory signal per se, the program instructions readable by at least one processing circuit to cause the at least one processing circuit to perform a method of object centric service delivery, the method comprising:
determining an individualized information of an object, wherein the object is from a plurality of objects, the individualized information comprising one or more performance parameters, wherein a performance parameter covers a performance area of the object, and wherein the performance parameter has a set of performance values;
sending the individualized information of the object to an object-centric service delivery system (OSDS);
creating a request for a financial aid, the request for the financial aid comprises an intended use of the financial aid, and a financial aid value;
sending the request for the financial aid to the object-centric service delivery system (OSDS);
receiving an integrated OSDS container wherein the integrated OSDS container is configured to service the request for the financial aid, wherein the integrated OSDS container comprises a financial aid value and a set of rules for utilizing the financial aid, wherein the set of rules for utilizing the financial aid are based on set of rules of one or more OSDS containers;
receiving recommendation of one or more service actions, wherein the one or more service actions facilitate the object in attaining the desired state, and wherein the recommendation of one or more service actions is based on an analysis of the individualized information of the object and individualized information of other objects that are contextually related to the object, wherein the other objects are from the plurality of objects.
